(19) United States
(12) Patent Application Publication
(10) Pub. No.: US 2024/0290318 A1
(43) Pub. Date: Aug. 29, 2024

(54) Training a Voice Recognition Model Using Simulated Voice Samples

(71) Applicant: Comcast Cable Communications, LLC, Philadelphia, PA (US)

(72) Inventors: Liming Zhang, Arlington, VA (US); Frederick Baldwin, New York, NY (US); Geoffrey Murray, Bethesda, MD (US); Ferhan Ture, Washington, DC (US); Taylor Cassidy, Asheville, NC (US); Kishorekumar Sundararajan, Sterling, VA (US); Lauren Michelle Reese, Philadelphia, PA (US); Pramod Kadagattor, Philadelphia, PA (US); Yidnekachew Endale, Waldorf, MD (US)

(21) Appl. No.: 18/179,931

(22) Filed: Mar. 7, 2023

Related U.S. Application Data
(60) Provisional application No. 63/448,130, filed on Feb. 24, 2023.

(51) Int. Cl. G10L 15/06; G06F 3/04847; G06F 40/279; G06F 40/30; G06V 30/19; G10L 13/04; G10L 13/08; G10L 15/22

(52) U.S. Cl. CPC G10L 15/063; G06F 3/04847; G06F 40/279; G06F 40/30; G06V 30/19007; G10L 13/04; G10L 13/08; G10L 15/22; G10L 2015/0635; G10L 2015/223

(57) ABSTRACT

Systems, apparatuses, and methods are described for generating simulated synthetic voice samples for use in training voice recognition models. The simulated synthetic voice samples may be diversified and in large quantities, in order to train the voice recognition models to handle a large variety of possible voice types and commands. These voice samples may be generated based on simulated user profiles indicating different types of speaker characteristics and words. The generated synthetic voice samples mimic realist human inputs and voice traffic, and may be used to test these voice recognition models for their performance in various situations. Based on the testing, these models may be efficiently retrained to improve their performance in a wide variety of conditions.

### CROSS-REFERENCE TO RELATED APPLICATIONS

This application claims the benefit of U.S. Provisional Application No. 63/448,130, filed on Feb. 24, 2023. The above-referenced application is hereby incorporated by reference in its entirety.

### BACKGROUND

Voice recognition systems rely on being able to understand a wide variety of human voice types (e.g., languages, dialects, speech patterns, etc.), and to support this ability, large numbers of diversified inputs need to be tested. However, obtaining such diversified inputs may be challenging due to privacy concerns, the volume of samples needed, and when new words and destinations need to be added to the system's existing vocabulary (e.g., movie titles with new words, actors with oddly-pronounced names, etc.).

### SUMMARY

The following summary presents a simplified summary of certain features. The summary is not an extensive overview and is not intended to identify key or critical elements.

Systems, apparatuses, and methods are described for generating simulated synthetic samples for use in evaluating language processing models. The simulated samples may include spoken and/or textual articulations of a human's intent to command a connected device. For example, the simulated samples may include requests for channel changes on a television, entertainment content, customer service requests, commands that configure devices in the person's environment, etc. The simulated samples may comprise text inputs to the system, their variations, as well as text inputs that are converted to speech waveforms via text-to-speech synthesis. The simulated synthetic samples may be diversified and in large quantities, in order to train the voice recognition models to handle a large variety of possible voice types and commands. These samples also allow evaluation of the performance of speech and text processing systems in a very cost effective fashion given that the correct answer is known at the time of generation. These samples, both the text and speech, may be generated based on simulated user profiles indicating different types of speaker characteristics and words. The generated synthetic voice samples mimic realistic human inputs and voice traffic, and may be used to test these voice recognition models for their performance in various situations. Based on the testing, these models may be efficiently retrained to improve their performance in a wide variety of conditions.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network in which the features described herein may be implemented.

FIG. 2 shows example hardware elements of a computing device that may be used to implement any of the devices described herein.

FIG. 3A and FIG. 3B show an example interface for user input for generating voice samples from an input text phrase.

FIG. 4 shows an example in which a computing device may be configured to perform various processes to generate voice samples from an input text phrase.

FIG. 5A and FIG. 5B show an example of another user interface that may be used to request the generation of voice samples from an input text phrase.

FIG. 6 shows a few examples of voice samples generated based on a single input text phrase.

FIG. 7A shows another interface for user input for generating voice samples, and FIG. 7B shows a way to stop the generation of voice samples.

FIG. 8 shows some examples of the generated voice samples using the interface as shown in FIG. 7A.

FIG. 9 shows an example in which a computing device may be configured to perform various processes to generate voice samples with different meanings based on inputted parameters.

FIG. 10 shows an example of sending the voice samples from FIG. 6 to a voice recognition system for testing the performance of the system.

FIG. 11A is an example flowchart showing a voice sample generation process, and FIG. 11B is an example flowchart showing a testing process for a voice recognition system using the generated voice samples.

FIG. 12A and FIG. 12B show an example of verifying transcription accuracy for ASR.

FIG. 13A and FIG. 13B show an example of verifying the performance of NLU.

FIG. 14 shows an example process of training ASR to generate the correct transcription.

FIG. 15 shows an example of screen output for a voice sample and an example process for evaluating the screen output.

FIG. 16 shows an example of another screen output for a voice sample.

FIG. 17A and FIG. 17B show two more examples of screen output for voice samples.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

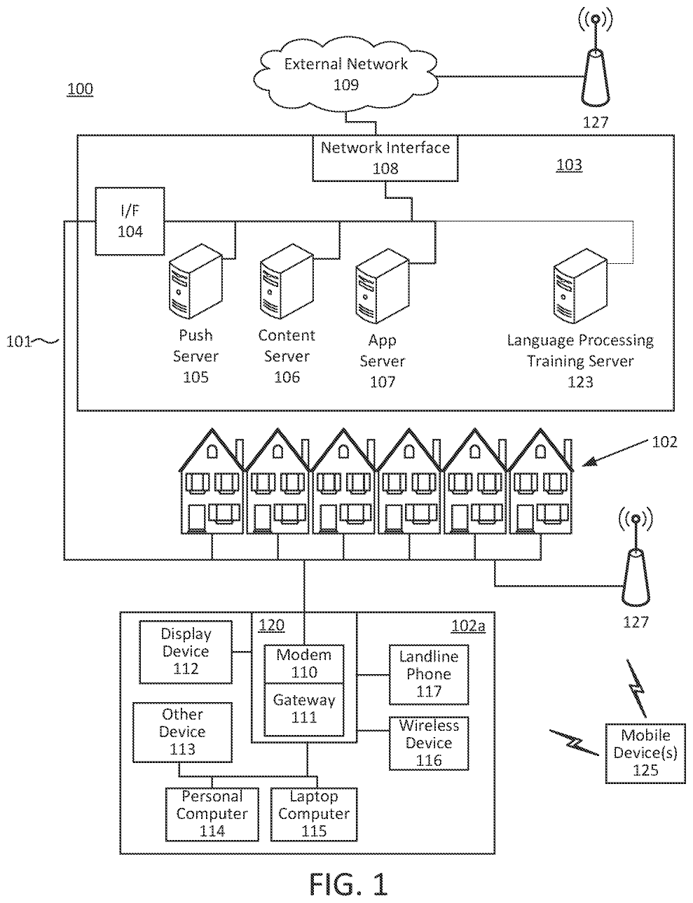

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as a language processing training server 123, additional push, content, and/or application servers, and/or other types of servers. The language processing training server 123 may perform various types of language processing, such as voice recognition. Training may include testing. Although shown separately, the push server 105, the content server 106, the application server 107, the language processing training server 123, and/or other server(s) may be combined and/or divided as desired. The servers 105, 106, and 107, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA)), landline phones 117 (e.g., Voice over Internet Protocol—VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

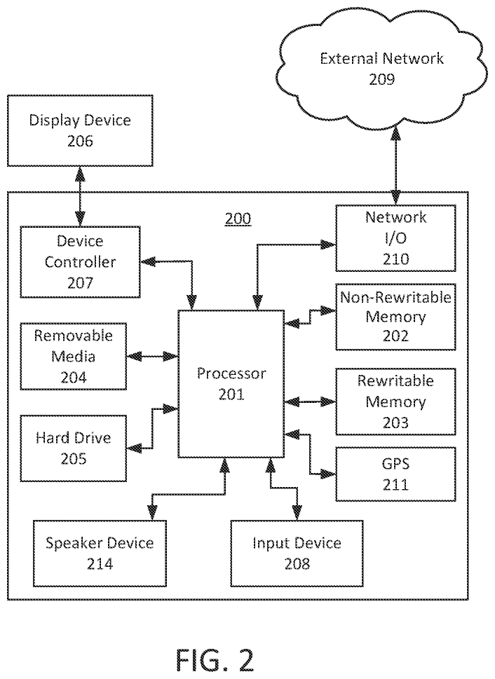

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein. The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

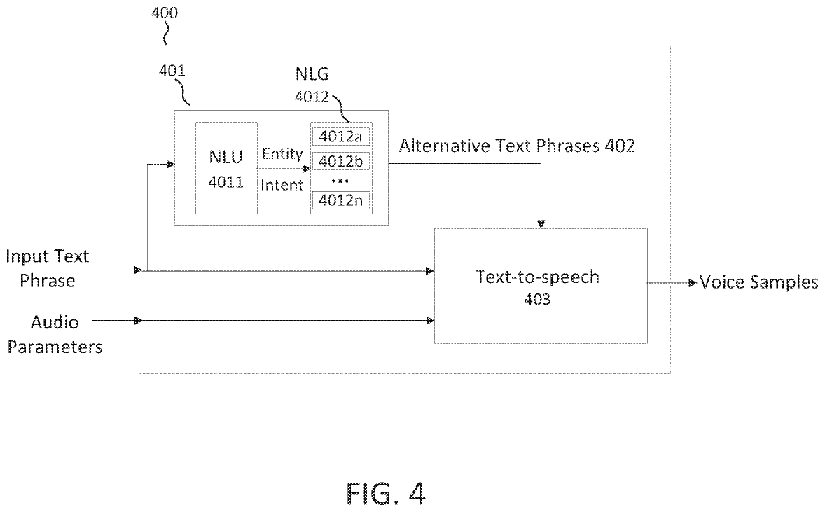

The language processing training server 123 may use simulated voice samples (or simulated spoken phrases) for the training purpose. These simulated voice samples may be generated by a voice sample generation process. The voice sample generation process may be executed on a computing device, for example, a server, a driver, and/or a processor. For example, the language processing training server 123 may execute instructions to provide a voice sample generation process. An example of the voice sample generation process may be represented by 400 in e.g. FIG. 4. The computing device (e.g., the language processing training server 123) that may execute the voice sample generation process may output a graphical user interface. A user may input parameters via the interface, so that a desired quantity/number of voice samples with desired accents and text content may be generated.

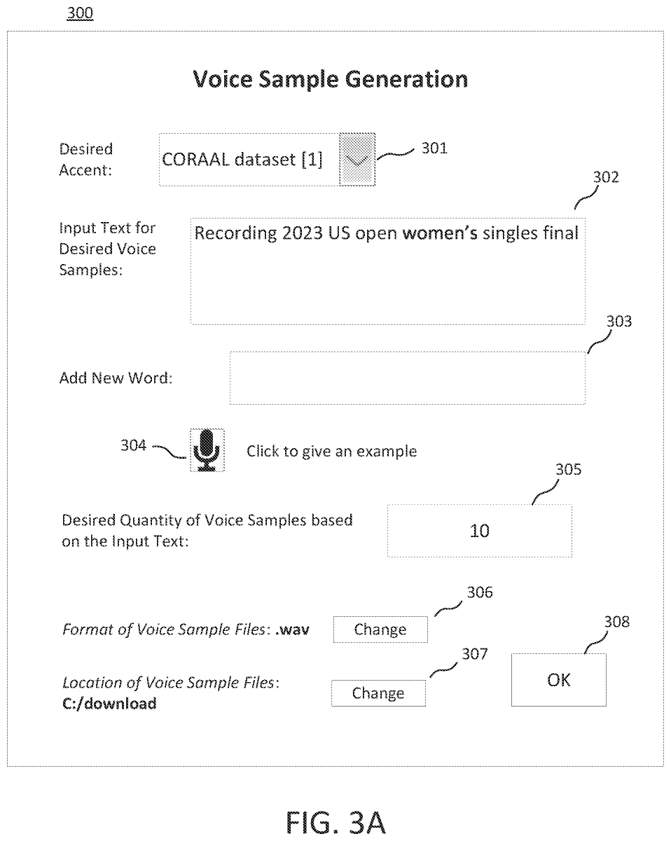

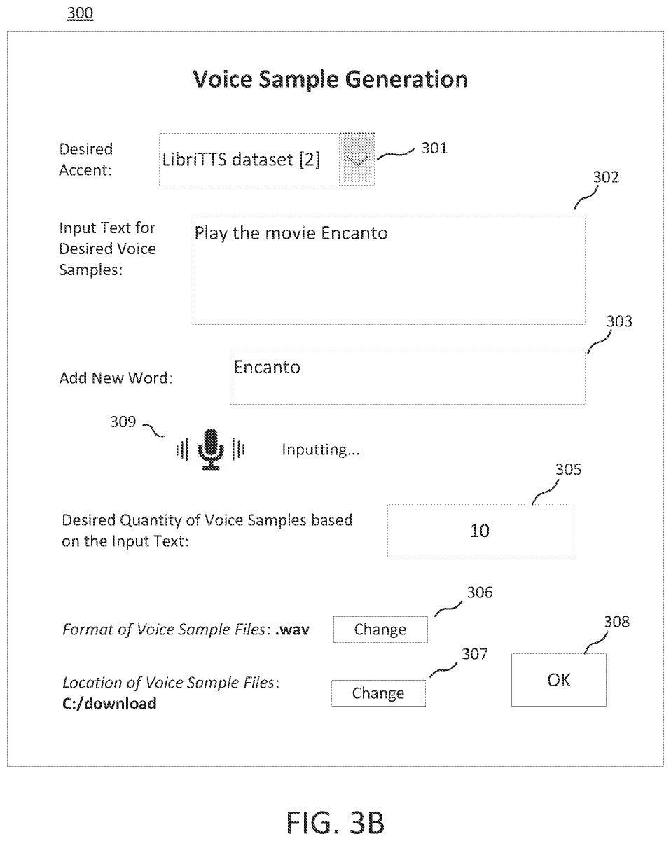

FIG. 3A and FIG. 3B show an example interface 300 for user input for generating voice samples from an input text phrase. For example, the language processing training server 123 may output the interface (e.g., user interface screen) 300 on an associated display device (e.g., a display connected to the language processing training server 123, a display 112 at a remote location, etc.), to allow a user to generate simulated voice samples. This example interface 300 may allow the user to choose one or more desired accents among the accent datasets in a dropdown box 301. In FIG. 3A, the example dataset is CORAAL dataset [1]. CORAAL (Corpus of Regional African American Language) is an online resource for English language data. In FIG. 3B, the example dataset is LibriTTS dataset [2]. LibriTTS is another online resource for Text-to-Speech research. The accent datasets are not limited to these two examples. They may include language datasets available in the market, and/or may include historical voice data obtained from customers. These datasets may be categorized and/or parameterized, so that they may be associated with and selectable based on language, country, region, ethnicity, and/or so on.

The example interface 300 may have a text box (or a second field) 302 for inputting a desired text phrase (e.g., a command) that the user wishes to simulate. The input text phrase (or input text) may be called a first text phrase. For example, in FIG. 3A, a user may type in “Recording 2023 US open women's singles final” in the text box 302, to generate simulated voice samples reading that phrase. If the user may suspect that any of the words he or she typed in may not have a matching pronunciation in the datasets—for example, that word may be a non-English word or a new non-US athlete name which may not be in the existing English-language datasets—the user may type the word(s) in a text box 303 and click a button 304 to input an example pronunciation of the word(s). For example, in FIG. 3B, for the text phrase “Play the movie Encanto”, the word “Encanto” may feel new and foreign to the user. In that situation, the user may type the word “Encanto” in the text box 303. The user may also, or alternatively, select one of the words in box 302 as a new word to be given a sample. The user may click the button 304, and speak this word aloud to a microphone. The microphone may be an accessory device of the computing device (e.g., the language processing training server 123) which executes the voice sample generation process. For example, the microphone may be the input device 208 in FIG. 2. FIG. 3B shows an icon 309 indicating that the microphone is listening to the user and taking in the pronunciation example. This pronunciation example may be stored, processed, and used for voice sample generation later.

In another example, a computing device may check the inputted text automatically by searching each inputted word in a selected accent dataset. If the computing device could not find a word in the dataset, the computing device may notify the user by e.g. highlighting that word in the inputted text. The user may choose to provide an example pronunciation for that word. If the user does not provide an example for a word that is not in the selected dataset, the computing device may use a default pronunciation for that word based on a general pronunciation rule in a selected language.

The example interface 300 may include an input area (or a first field) 305 to allow a user to indicate a desired quantity of voice samples that are to be generated. A user may input any quantity from one to tens of thousands or even millions. If the inputted quantity is more than one, variations of the inputted text phrase may be generated. For example, the variations may be generated by using different sentence structure (e.g., rearranging verbs and nouns), different terminology (e.g., using synonyms for some or all of the words in the text phrase), omission of one or more words, etc., to simulate the many ways in which users may try to speak the text phrase. This will be described in detail below.

The desired accent, the input text for desired voice samples, the desire quantity of voice samples, and/or so on may be examples of input parameters for generating a plurality of simulated voice samples or simulated spoken phrases. The example interface 300 may further include information on the default format of generated voice sample files and the default location for saving the voice sample files. The default voice sample format may be wav, or any other desired format such as mp3, m4a, wma, etc. The user may click button 306 to change the voice sample format. The default location may be the download folder on the C: drive of the computing device (e.g., the language processing training server 123). Similarly, the user may click button 307 to change the location for saving the voice sample files. The user may click button 308 to proceed with generating voice samples.

FIG. 4 shows an example in which a computing device (such as the language processing training server 123) may be configured to perform various processes to generate voice samples from an input text phrase. Specifically, FIG. 4 shows an example of how the language processing training server 123 (or any other computing device) may be configured with various processes to automatically generate a plurality of simulated voice samples (or simulated spoken phrases) based on an input text phrase (or first text phrase), such as the “Play the movie Encanto” phrase in FIG. 3B. The plurality of simulated voice samples (or simulated spoken phrases) may comprise grammatical variants of the input text phrase (or first text phrase). That input text phrase may be provided (e.g., sent) to a text diversifying process 401, which may generate a variety of alternative text phrases 402 based on the input text phrase. The text diversifying process 401 may include a Natural Language Understanding (NLU) process 4011 and a Natural Language Generation (NLG) process 4012. The NLU process 4011 may recognize entity and intent from the input text phrase using syntactic and semantic analysis of the text, and may record and provide the entity and intent (e.g., entity and intent terms) to the NLG process 4012. The intent may refer to a verb (e.g., an action) of the entered text phrase, while the entity may refer to a subject (e.g., a noun) of that verb. For example, for the input phrase “Play the movie Encanto”, the recognized entity may be “movie Encanto”, and the recognized intent may be “play”. Any existing NLU programs may be used for the NLU process 4011.

The NLG process 4012 may generate alternative text phrases based on the entity and intent. The NLG process 4012 may have one or more linguistic databases including a synonym database 4012a, a syntactic database 4012b, and/or other linguistic databases 4012n. The one or more linguistic databases in the NLG process 4012 may be used to generate alternative text phrases 402 based on the entity and intent provided by the NLU process 4011. The synonym database 4012a may contain a thesaurus-type database of synonyms for various words in a language. The synonym database 4012a may be context-specific, such that there may be different databases for different contexts in which the input text phrase is to be used. For example, if the input text phrase is to be used for controlling the recording of a video program, then there may be a video program synonym database 4012a that is focused on terminology in the context of video programs. This may be helpful, for example, if certain terms have different meanings in different contexts. For example, in a video program context, the word “play” may refer to starting playback of a video program, and may refer to a theatrical production, but there may be other meanings (e.g., playing children, playing a musical instrument, etc.) that do not apply in the video program context. The synonym database 4012a may indicate, for example, that the term “play” in the video program context may be synonymous with “playback” and “start.” So the input phrase “Play the movie Encanto” may result in textual alternatives “Playback the movie Encanto” and “Start the movie Encanto.” The synonym database 4012a may indicate that the term “movie” is synonymous with “video” and “program,” so the input phrase “Play the movie Encanto” may result in textual alternatives “Play the video Encanto” and “Play the program Encanto.” In a movie context, the synonym database 4012a may further indicate that the term “movie Encanto” is synonymous with “Encanto”, so the input phrase “Play the movie Encanto” may result in a textual alternative of “Play Encanto”.

The syntactic database 4012b may contain rules for varying the syntax or grammar of phrases. For example, the syntactic database 4012b may include a rule regarding the addition of an interjection such as “Please” to the beginning and/or end of a command. Accordingly, the input phrase “Play the movie Encanto” may result in a textual alternative of “Please play the movie Encanto.” The syntactic database 4012b may include a rule regarding rearranging sentence structure in English, so the input phrase “Play the movie Encanto” may result in a textual alternative of “Encanto, play please.” Although synonyms and syntax rules are described, there may be any variety of linguistic databases for determining alternative text phrases 402.

The various databases may individually result in alternative text phrases as discussed above, and their information may also be combined to result in even more alternative text phrases. For example, the syntactic database 4012b may indicate that the word “please” may be added, and the synonym database 4012a may indicate a variety of synonyms for the word “please,” resulting in a variety of additional alternative text phrases, such as “Do me a favor and play the movie Encanto” and/or “Would you mind playing the movie Encanto?”

The various alternative text phrases, as well as the original input text phrase, may be supplied to a text-to-speech process 403 for conversion into audio files reading the text phrases aloud. The text-to-speech process 403 may also receive audio parameters, such as the parameters described in FIGS. 3A-B and 5B, to control the audio announcement of each of the text phrases. For example, if one parameter indicated that a voice sample should be read with a Texas accent, then the text-to-speech process 403 may convert a text phrase into an audio sample using Texas accent phonemes. The text-to-speech process 403 may generate a plurality of audio files, each containing an audio of a text phrase spoken according to the input audio parameters. As will be discussed below, these audio files may then be played for a voice recognition (or language processing) process, to train that process in recognizing the variations of the input text phrase. The text-to-speech process 403 may use any existing text-to-speech, text-to-voice, or text-to-audio system.

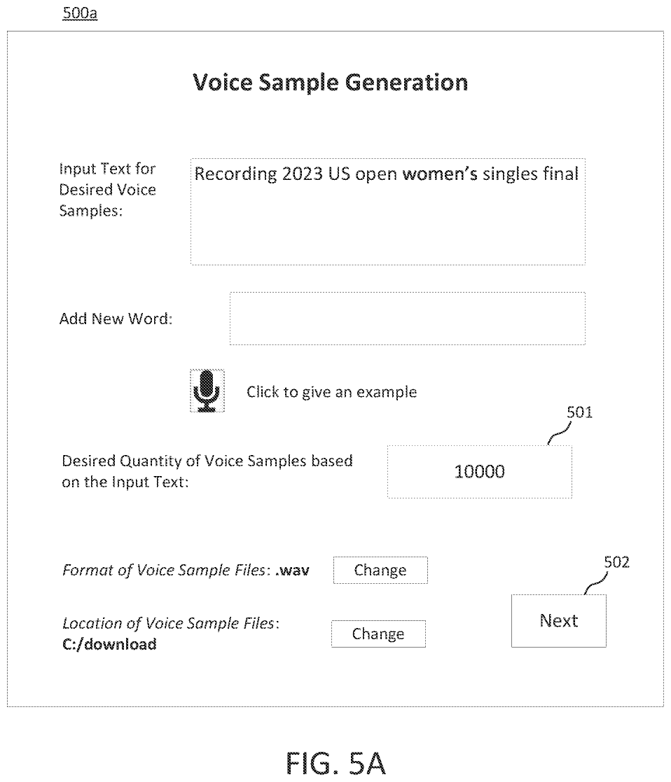

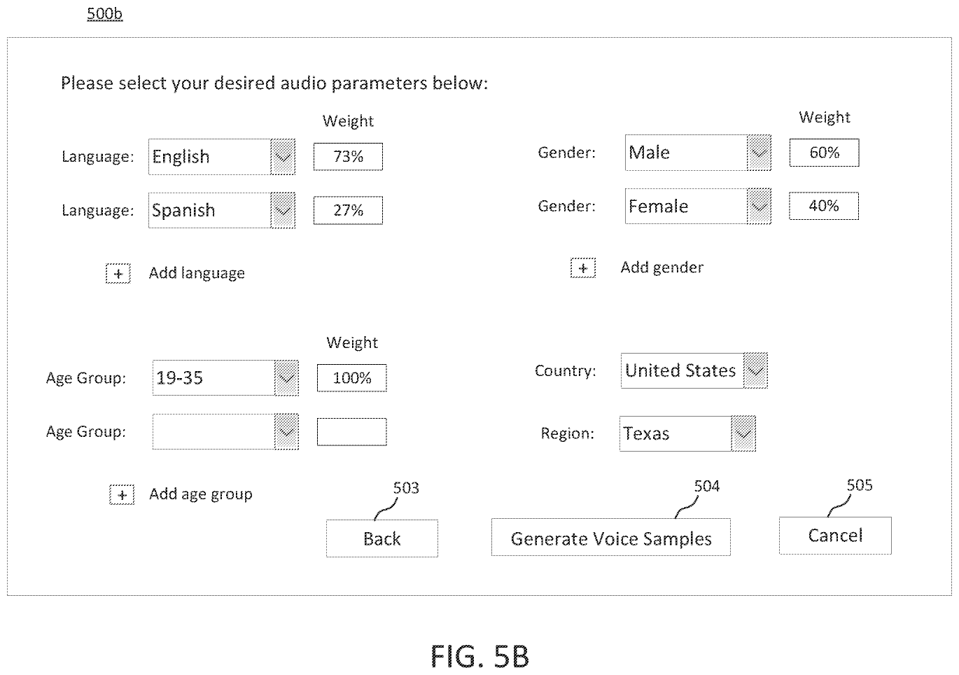

The various databases such as the synonym database 4012a and the syntactic database 4012b may be updated regularly or dynamically to keep up with new language trends. For example, new slangs, trendy words may be included in the synonym database. More details of the voice recognition generation process 400 will be described below with respect to the example as shown in FIG. 5A and FIG. 5B.

FIG. 5A and FIG. 5B show an example of another user interface that may be used to request the generation of voice samples from an input text phrase. FIG. 5A may have an interface 500a similar to the interface 300 in FIG. 3A. For example, the interface 500a may comprise an input area (or a first field) 501. In this interface (e.g., user interface screen) 500a in FIG. 5A, the accent selection box 301 in FIG. 3A may be omitted. Instead of providing a list of specific accents for the user to choose from (e.g., the accent selection box 301), the whole interface may comprise a separate window (e.g., an interface 500b as shown in FIG. 5B) with a plurality of detailed selection items for creating one or more customized accents focused on groups of people. The interface 500b in FIG. 5B may appear after a user exits (e.g., clicks the button 502 in) the interface 500a as shown in FIG. 5A. The interface (e.g., user interface screen) 500b may be used for inputting the user's desired audio parameters which may be details of a desired language, accent, and/or other voice characteristics. For example, certain country and/or region may be associated with an accent. Gender and age may impact the voice characteristics. The interface 500b may allow the user to select more than one option under each parameter and give each option a respective weight (e.g., percentage value) to indicate a desired distribution among the generated voice samples (e.g., an English language weight of 73% may result in 73% of the samples being in the English language). This may allow the generation of a number of voice samples that may reflect distributions (e.g., percentage distributions) or distribution patterns of languages, accents (e.g., regional accents), and/or voices that may be associated with gender, age, and/or so on. Such voice samples may mimic a real-life situation, e.g. voice traffic for a selected region, a group of people, and/or an upcoming event, and may be used to train voice recognition (or language processing) models to prepare for those situations. The input text for desired voice samples, the desired quantity of voice samples, the desired audio parameters, and/or so on may be examples of input parameters for generating a plurality of simulated voice samples or simulated spoken phrases.

In FIG. 5A, the desired quantity of voice samples may be a large quantity, for example 10,000. In FIG. 5B, the user may select more than one language and give each one a respective weight. The user may do the same to gender, age group, etc. In the example, English and Spanish may be selected and given a weight of 73% and 27%, respectively. Male and Female may be selected and given a weight of 60% and 40%, respectively. The age group 19-35 may be selected and given a 100% weight. Besides, the interface 500b may allow the user to choose specific country and region. In this example, the user may select United States as the country and Texas as the region. The inputs as shown in FIGS. 5A and 5B may indicate the user's desire to generate 10,000 voice samples for “Recording 2023 US open women's singles final”, with the 10,000 voice samples having diverse language formation. And among the 10,000 diverse voice samples, it may be desired that 7,300 (73%) are in the English language and 2,700 (27%) are in the Spanish language, that 6,000 (60%) are in male voice and 4,000 (40%) are in female voice, that the voices are from speakers of 19 to 35 years old with a U.S. Texas accent. The user may click button 503 to go back to the previous interface 500a to revise text, quantity, etc. Alternatively, the user may click button 504 to generate voice samples, or click button 505 to cancel the generation.

The process to generate the desired quantity of voice samples with the desired distributions may be realized by the voice sample generation process 400 as shown in FIG. 4. The input text phrase (e.g., “Recording 2023 US open women's singles final”) may be provided to the text diversifying process 401, which may generate a variety of alternative text phrases 402 based on the input text phrase. Specifically, the NLU process 4011 may recognize or extract entity terms (e.g., “2023/US open/women/singles/final game”) and intent terms (e.g., “record”) from the input text phrase using syntactic and semantic analysis of the text, and the NLG process 4012 may generate diversified text phrases based on the extracted entity and intent. The synonym database in the NLG process 4012 may replace the entity and intent terms with synonyms. For example, “2023” may be synonymous with “year 2023”. “US open” may be synonymous with “US tennis”, “US open tennis”, “US tennis championships”, and/or so on. The term “women” may be synonymous with “female”, “females”, “woman”, “lady”, and/or so on. The term “singles” may be synonymous with “singles tennis”, “singles game”, and/or so on. The term “final game” may be synonymous with “finals”, “final match”, and/or so on. The term “record” may be synonymous with “recording”, “make a copy of”, and/or so on. The syntactic database in the NLG process 4012 may provide syntax or grammar rules for connecting the entity and intent terms (including their synonyms) in various orders to form text phrases. The syntax or grammar rules may include adding prepositions and/or so on for the connection. The rules may also include adding interjections such as “please”, “now” to make more variations of the text phrases. The syntactic database may have multiple datasets and/or may be parameterized, as the syntax or grammar rules may be different for different languages, locations, age groups, etc. The NLG process 4012 may form alternative text phrases based on the input text phrase, using at least the synonym and syntactic databases. Examples of the alternative text phrases may include “Record female singles tennis final match in 2023 US open”, “Help me record US open lady's single final in 2023”, “Make a copy of final game US tennis 2023 for women's singles, please”, and/or so on.

The NLG process 4012 may further include a machine translation model for generating alternative text phrases that are in a language different from the language used by the input text phrase. The machine translation model may translate entity/intent terms and their synonyms into a second language. The NLG block 4012 may use syntax or grammar rules for the second language as provided in the syntactic database to connect the translated terms to form text phrases. For example, the terms “final” and “record” may be translated to “final” and “grabar” in Spanish. When connecting the two terms “final” and “grabar”, syntax/grammar rules in Spanish may be used to make a phrase “grabe la final”. In another example, the machine translation model may translate the alternative text phrases already formed by the NLG process 4012 into a second language. For example, an alternative text phrase “Record the 2023 US Open women's singles final” may be sent to the machine translation model which may translate this phrase into a second language (e.g., Spanish): “Grabe la final individual femenina del US Open 2023”. Any existing machine translation models may be used in the NLG process 4012. As a result, the alternative text phrases 402 generated from the text diversifying process 401 may be in more than one language.

The alternative text phrases 402 as well as the original input text phrase may be provided to the text-to-speech process 403 for generating voice samples. The text-to-speech process 403 may have various databases related to voice or audio characteristics. For example, the text-to-speech process 403 may have an accent database for each language that may include at least one accent dataset. The accent database may contain voice data that may be different phoneme audio files for different pronunciations (e.g., accents) of words. The voice data (e.g., audio files) may be from sources where information of the original speakers is available. And the voice data (e.g., audio files) may be tagged with information or parameters related to the original speakers, such as gender, age, country, region, and/or so on. When desired audio parameters are inputted via an interface (e.g., the one as shown in FIG. 5B), corresponding voice data (e.g., audio files) tagged with parameters that match those inputted parameters may be selected as matching voice data to be used for synthesizing with the text phrases to generate voice samples. These matching voice data (e.g., audio files) may be given a sequence of numbers, for example, 500 numbers. A random seed may be used to pick randomly from that sequence of numbers (e.g., 500 numbers), so that the matching voice data (e.g., audio files) may be randomly selected to be used for synthesizing with one of the text phrases. For example, a number of phoneme audio files (e.g., 500) in an accent database for the English language may be selected based on the desired audio parameters as shown in FIG. 5B, as each one of these files has parameters including gender (male or female), age (an age that falls into the age group 19-35), country (United States), and region (Texas). Among these audio files, for example, one file may have parameters: male, 25, United States, Texas, and another file may have parameters: female, 19, United States, Texas. They are both selected because their parameters match the desired parameters as inputted on the user interface in FIG. 5B. These selected audio files may be called matching voice data and may be given a sequence of numbers, for example, 001 to 500. When generating voice samples, the text-to-speech process 403 may randomly select a text phrase received from e.g. the text diversifying process 401, and may synthesize the selected text phrase with one of the matching audio files randomly selected among the sequence of numbers, for example, 500 numbers. The result of the synthesizing is a desired voice sample. For example, the audio file with parameters: female, 19, United States, Texas is randomly selected for synthesizing with a randomly selected text phrase “Recording 2023 US open final match for women's single”. The resulting voice sample may be a young female voice with a Texas accent speaking the command “Recording 2023 US open final match for women's single”. Even within the same accent or same group of parameters, there may be variations. For example, there may be more than one audio files that have the parameters: female, 19, United States, Texas. For example, one of the files may be a 19-year-old Texas woman who has a high pitch in her voice, and another one of the files may be a 19-year-old Texas woman who has a coarse voice because she smokes. Thus, even when a random seed selects the same accent or same group of parameters more than once, the voices may still be different. With such depth of variations in voices and the random picking of both the voices and alternative text phrases, the generated voice samples may have sufficient variations to represent diversified voices in a selected gender, age group, country/region, and/or so on. Further, these voice samples may present a more realistic voice traffic when they are used for testing a voice recognition (or language processing) system such as a voice-controlled smart television.

To generate a desired quantity of voice samples, for example, 10,000, the voice sample generation process 400 may have a counter in e.g. the text-to-speech process 403 for counting the quantity/number of voice samples already generated. The text-to-speech process 403 may stop the voice sample synthesizing process when a desired quantity (e.g., 10,000) of voice samples is reached and may save the voice samples in a designated format in a designated location. In a situation where the desired audio parameters are given weights, for example, as shown in FIG. 5B, the voice sample generation process 400 may further have a calculator in e.g. the text-to-speech process 403 to work with the counter. The calculator may calculate a desired quantity for each desired parameter based on the desired total quantity of voice samples and the weights, and the text-to-speech process 403 may select voice data (e.g., audio files) accordingly. For example, if a desired quantity of voice samples is 10,000, and if 73% of them are in English, 27% are in Spanish, 60% are male voices, 40% are female voices, and all of them are from speakers of 19 to 35 years old in Texas of United States, then the following may apply: 7,300 audio files from the English language accent database may be selected, all of which having age parameters within the group 19-35 and country/region parameter United States/Texas, among which there are 4,380 files with gender parameter male and 2,920 files with gender parameter female; and 2,700 audio files from the Spanish language accent database may be selected, all of which having age parameters within the group 19-35 and country/region parameter United States/Texas, among which there are 1,620 files with gender parameter male and 1,080 files with gender parameter female. Further, the text diversifying process 401, specifically, the NLG process 4012 may use the machine translation model to translate a corresponding quantity of text phrases to a second language based on the calculation of the calculator. For example, the NLG process 4012 may use the machine translation model to translate, from English to Spanish, 2,700 text phrases randomly picked from the randomly generated alternative text phrases. These 2,700 text phrases in Spanish may be used to combine with the 2,700 audio files selected from the Spanish language accent database to generate voice samples that indicate the distribution of audio parameters as shown in FIG. 5B. Similarly, 7,299 text phrases randomly selected from the alternative text phrases in English generated from the text diversifying process 401 and the one original input text phrase in English may be used to combine with the 7,300 audio files selected from the English language accent database to generate voice samples that indicate the distribution of audio parameters as shown in FIG. 5B.

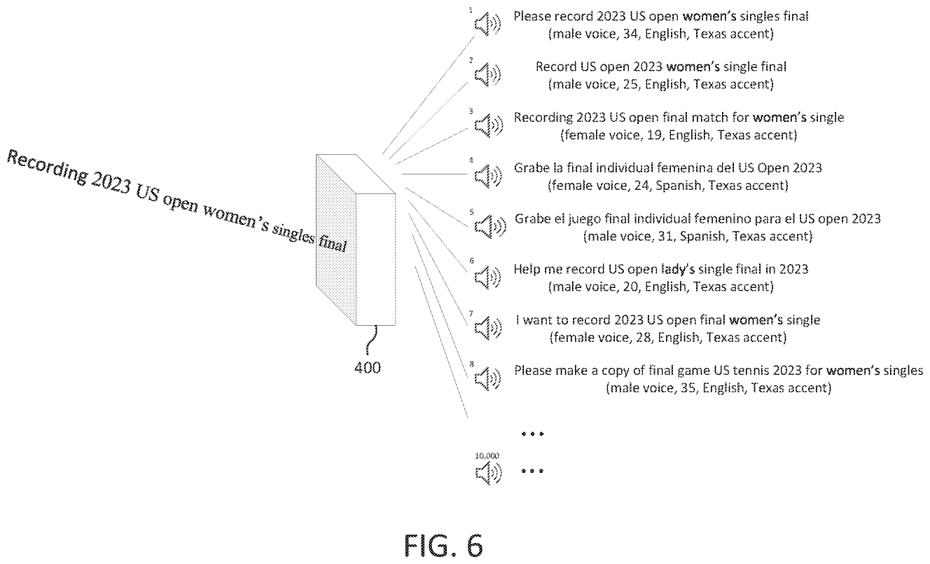

FIG. 6 shows a few examples of voice samples generated based on a single input text phrase. In FIG. 6, after the voice sample generation process 400 may receive inputs including an initial text phrase “Recording 2023 US open women's singles final” as shown in FIG. 5A, the process may generate 10,000 diversified voice samples as desired. Among the examples shown in FIG. 6, there may be some voice samples in the English language, and some others in the Spanish language. The voices may be from speakers with a gender, age, and region-specific accent that match the user's inputs. For example, one voice may belong to a speaker who is male, 34 years old, and with a Texas accent. Another voice may be from a speaker who is female, 24 years old, and with a Texas accent. The text phrases of these voice samples may differ from each other but may have the same meaning. For example, for two English commands, one may say “Record US open 2023 women's single final”, and another may say “Please make a copy of final game US tennis 2023 for women's singles”. They may look different, but “Record” and “Please make a copy of”, “US open 2023” and “US tennis 2023”, “final” and “final game”, “women's single” and “women's singles” may mean the same respectively. As mentioned above, these synonymous text phrases may be generated by at least a synonym database and a syntactic database in the NLG process 4012 in FIG. 4.

In the example interface 500b in FIG. 5B, a user may select one country and one region. The interface 500b may also allow the user to choose more than one country and/or region. The interface 500b may allow the user to choose names of accents instead of country/region names. For example, the user may choose British accent and Australian accent and give them respective weights. In that situation, the accent databases for the text-to-speech process 403 may include voice data (e.g., audio files) parameterized with names of accents. The interface may also allow selection of parameters such as ethnicity, education level, smoker/non-smoker, speech impediment, etc., as long as these parameters have been assigned to corresponding voice data.

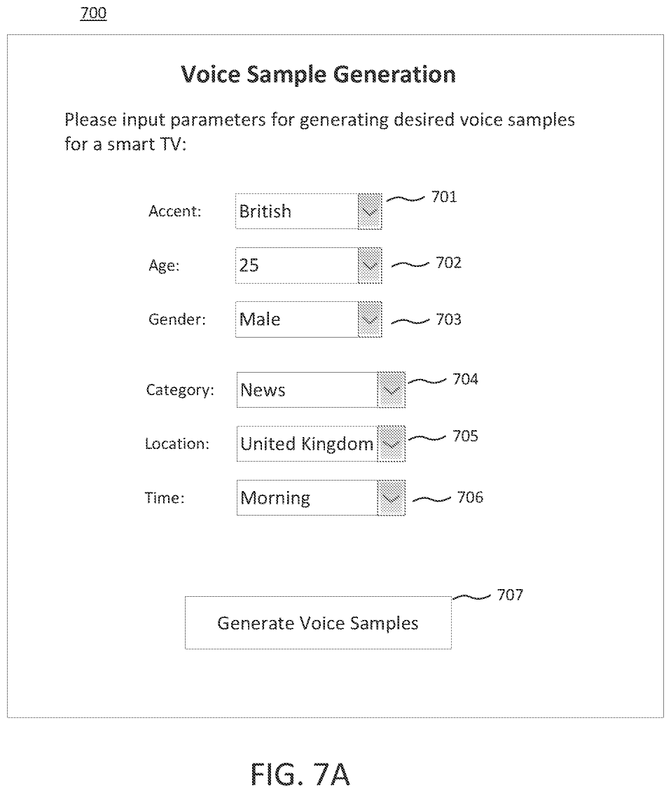

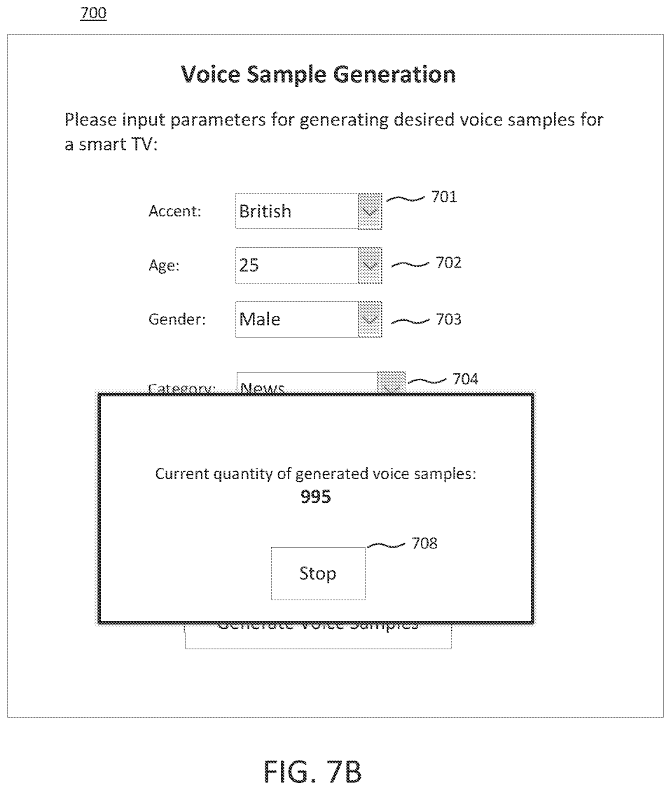

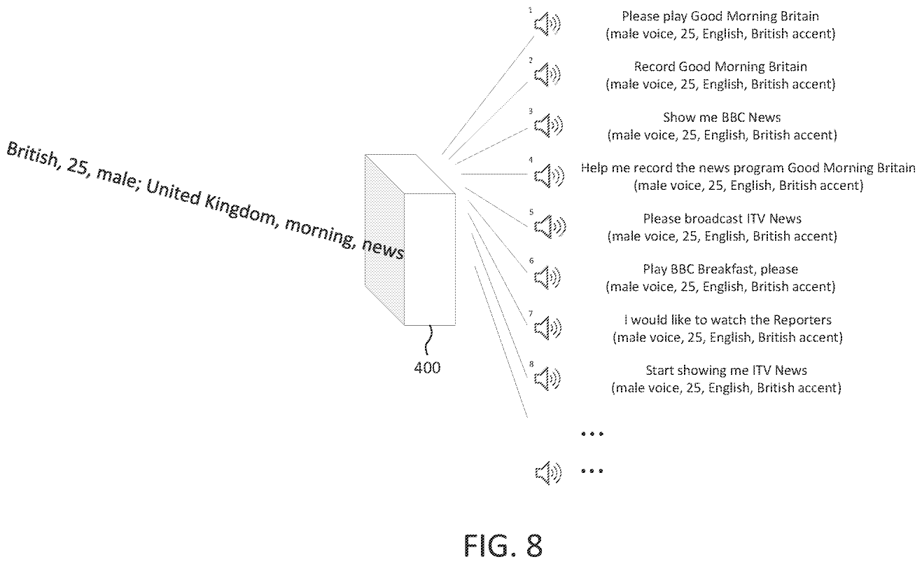

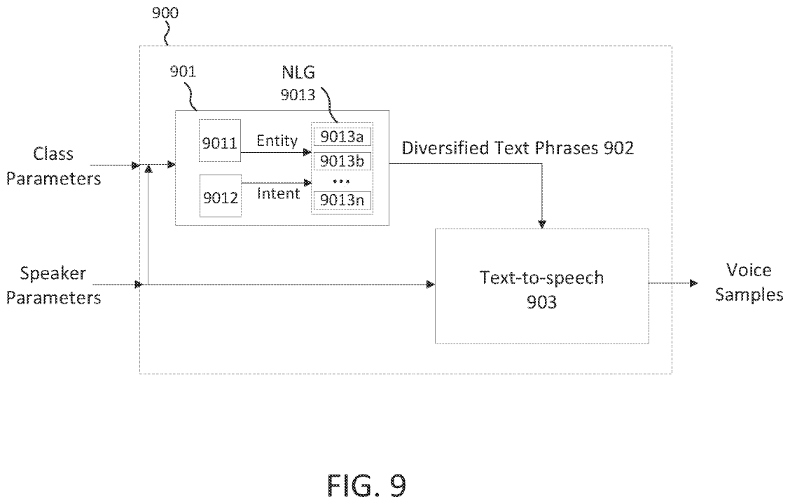

FIG. 7A shows another interface for user input for generating voice samples. This interface (e.g., user interface screen) 700 may be used for generating voice samples with different meanings automatically. The interface 700 (and related databases) may be designed for a specialized context (e.g., video-related commands, such as those for programs of a smart television), and may allow the user to specify the entity in a more generic way. Instead of identifying a particular entity by name, such as the “Encanto” example above, the user may simply identify a class of entity, and a program listing database (e.g., a catalog database 9011 as will be described below with respect to FIG. 9) may be searched to find example entities of the class. For example, the user may enter a program category of “news” 704, a location 705 of “United Kingdom,” and a time 706 of “Morning.” A program listing may be searched to find one or more morning news programs in a program listing for the United Kingdom, and those news programs may be used as entities for generated voice samples. The intent may be generated automatically based on the specialized context. In this example, as the context is commands for video (e.g., television) programs, an action listing database (e.g., an action database 9012 as will be described below with respect to FIG. 9) may be used to generate intents such as “play”, “watch”, etc. These intents may be combined with the entities to generate commands. This can be used to simplify generation of voice samples for commands used in a specialized context, for example, video-related commands, such as those for a smart television. In this interface 700, a user may input speaker parameters such as accent, age, gender, by e.g. selecting a desired parameter from a dropdown box. The user may further input class parameters that may define a scope of the content of the voice samples to be spoken by the desired speakers. The class parameters may comprise category, location, and time. These parameters may be selected from dropdown boxes. For example, in FIG. 7A, a user may select British accent in a dropdown box 701, age 25 in a dropdown box 702, and male gender in a dropdown box 703. The user may also select news as category in a dropdown box 704, United Kingdom as location in a dropdown box 705, and morning as time in a dropdown box 706. After the user clicks the button 707, the voice sample generation process may generate voice samples that are spoken in voices with the desired speaker parameters and that have content with the class parameters. For example, a generated voice sample may be about showing a morning news television program in the United Kingdom (e.g., “Play BBC Breakfast, please”) and may be spoken in a young male voice with a British accent. More examples of generated voice samples are shown in FIG. 8 and will be described below. For the interfaces in FIGS. 3A, 3B, and 5A, the user may need to input a text phrase multiple times in order to generate voice samples with different meanings. For the interface in FIG. 7A, the user may generate a variety of voice samples with different meanings at one click. This way of generating voice samples may be faster, more convenient and comprehensive especially when the voice samples are for a specialized context or area. For a specialized context or area, the vocabularies may be of a manageable size, and the relevancy and accuracy of generated voice samples may be easier to maintain. The class parameters may further reduce the size of vocabulary and workload of the voice sample generation process.

The interface 700 in FIG. 7A may provide an input area (e.g., a first field) that allows a user to input a desired quantity of voice samples, like the input areas 305 and 501 discussed above. Alternatively, FIG. 7B shows a way to stop the generation of voice samples. After the user clicks the button 707 in FIG. 7A, a popup window may appear which may inform the user how many voice samples have been created. The quantity of voice samples may change in real time in the popup window to show the actual progress of the voice sample generation process. For example, the popup window in FIG. 7B may show that the current quantity or updated value of generated voice samples is 995. This quantity may be increased to e.g., 1050 very soon. The popup window may also provide a button to stop further generation of voice samples (e.g., stop button 708). When a user clicks the stop button 708, the voice sample generation process may be stopped, and the current quantity on the window may stay as the total quantity of voice samples created. This function may be realized using any existing programming methods. The speaker parameters, the class parameters as described above, and/or so on may be examples of input parameters for generating a plurality of simulated voice samples or simulated spoken phrases.

FIG. 8 shows some examples of the generated voice samples using the interface as shown in FIG. 7A. These example voice samples may all be spoken in a young male voice with a British accent. As described above with respect to FIG. 4, the audio parameters: male, 25, British accent may correspond to multiple audio files, and these audio files may provide different voices although they have the same audio parameters. For example, one male of 25 years old may speak British English with a coarse voice, and another male of 25 years old who speaks British English may have a clearer voice. Besides the variations in voices, these voice samples may have content that randomly include different names that match the class parameters. For example, in the context of video content (e.g., programs of smart television) and with the class parameters being News/United Kingdom/Morning, the voice samples may have names of video (e.g., television) programs that are morning news in the United Kingdom. FIG. 8 shows a few examples such as “Good Morning Britain”, “BBC Breakfast”, “Reporters”. The voice samples may also have intent words to connect with the names to form phrases (e.g., commands). In the context of video content (e.g., programs of smart television), the intent words may be verbs and/or their varied forms that are related to common user operations for video content (e.g., television programs), for example, “play”, “show me”, “record”. In addition, the voice samples may have other words to increase variations without changing the meaning, for example, “please”, “I would like”, “start”. These names, intent words, and other words, as well as their synonyms, may be connected using syntax or grammar rules which may involve different orders, adding or dropping words etc., to form phrases that simulate real-life user commands to control a voice recognition system such as a video display device (e.g., a smart television). Examples include “Please play Good Morning Britain”, “I would like to watch the Reporters”, “Start showing me ITV News”, and/or so on. The synonyms and syntax/grammar rules may be provided by the synonym database and syntactic database as described above with respect to FIG. 4.

FIG. 9 shows an example, similar to that in FIG. 4, in which a computing device (such as the language processing training server 123) may be configured to perform various processes to generate voice samples with different meanings based on inputted parameters in e.g. FIG. 7A. The voice sample generation process 900 may have a text phrase generation process 901 and a text-to-speech process 903 for generating voice samples in a designed context. The text-to-speech process 903 may be similar to the text-to-speech process 403 in FIG. 4. The text-to-speech process 903 may select voice data (e.g., audio files) that match the inputted speaker parameters or audio parameters and synthesize the voice data with diversified text phrases 902 generated from the text phrase generation process 901 to generate voice samples. The text phrase generation process 901 may have an NLG process 9013 which may be similar to the NLG process 9012 in FIG. 4. The NLG process 9013 may include at least one synonym database 9013a, a syntactic database 9013b, and other databases 9013n as needed. so that the NLG process 9013 may generate various text phrases based on the entity/intent terms provided to it. Different from FIG. 4, the text phrase generation process 901 may not have an NLU process, because there is no input text phrase for a machine to understand. Instead of extracting entity and intent from an input text phrase using NLU, the text phrase generation process 901 may have a catalog database 9011 for storing a vocabulary (or entities) that may be relevant to the context and an action database 9012 for storing a vocabulary (or intents) that may work with the catalog vocabulary (or entities) in the context. The catalog database 9011 and action database 9012 may provide entity and intent terms to the NLG process 9013 for generating natural language text phrases. For example, the context may be video. The catalog database 9011 may contain video (e.g., television program) names, and the action database 9012 may contain words indicating user operations (e.g., play, record) for videos (e.g., television programs). The vocabulary in at least the catalog database 9011 may be parameterized and may have parameters that correspond to the class parameters inputted by a user on an interface such as the one shown in FIG. 7A. For example, in the video (e.g., smart television) context, the video names in the catalog database 9011 may have parameters such as category, location, and time. The category may include categories/types of videos (e.g., television programs) such as news, sports, drama, kids. The location may include country, region, city names, and/or so on. The time may include morning, evening, noon, Christmas, and/or so on. Thus, when a user selects a certain parameter in the interface in FIG. 7A, vocabulary (e.g., names, terms) with that parameter in the catalog database 9011 may be selected. For example, the video (e.g., television program) name “BBC Breakfast” may have parameters including category (news), location (United Kingdom), time (morning). When a user inputs “News”, “United Kingdom”, “Morning” in dropdown boxes 704, 705, and 706 in FIG. 7A, the name “BBC Breakfast” will be selected from the catalog database 9011 and provided to the NLG process 9013 as one of the entity terms. For another example, a video (e.g., television program) name “Sports Night” may have parameters including category (news), location (United States), time (evening). When a user inputs “News”, “United Kingdom”, “Morning” in dropdown boxes 704, 705, and 706 in FIG. 7A, the name “Sports Night” will not be selected from the catalog database 9011 as the parameters do not match.

These class parameters may be useful for specifying entity names, for example, if a user does not wish to specifically type one into a text box (e.g., text box 302 as shown in FIG. 3B). These class parameters may also be useful for generating a group of targeted entity terms quickly, and the resulting voice samples may serve certain testing purposes. The quantity of class parameters may be added or reduced. For example, the parameter time may have an option “Any time”, so that there is no restriction on this parameter. In other words, the parameter time may be removed. Alternatively, the interface as shown in FIG. 7A may allow adding or removing one or more parameter dropdown boxes from the interface, so as to change the quantity of parameters. The class parameters may be other parameters besides category, location, time. For example, the class parameters may comprise language. The class parameters may be determined based on the specialized context of the interface 700 (and related databases). For example, if the specialized context is voice-controlled vending machines, the class parameters may comprise parameters such as product category, product status, etc.

The speaker parameters as inputted by a user may also affect the selection of vocabulary in e.g. catalog database 9011. For example, a 25-year-old male with a British accent may prefer some videos (e.g., television programs) more than others. For example, in the morning news category, a typical 25-year-old male with a British accent may prefer watching Good Morning Britain than BBC Breakfast. Such preferences may be obtained from historical viewer data, for example, viewing records in the past by a selected group of audience. By parameterizing the vocabulary in e.g. catalog database 9011 with parameters related to the speakers, such as gender, age, accent, more relevant vocabulary may be selected from e.g. the catalog database 9011, and the content of resulting voice samples may be more relevant to the speakers. For example, the video (e.g., television program) name “Good Morning Britain” may have parameters including male, young, British accent, and the video (e.g., television program) name “BBC Breakfast” may have parameters including female, middle age, British accent. Among the voice samples generated based on the parameters inputted as shown in FIG. 7A, we may have a British young male's voice requesting a video display device (e.g., a television) to play Good Morning Britain, which may sound more realistic than if he requests the video display device (e.g., a television) to play BBC Breakfast. Although the catalog database 9011 is used as an example to describe parameterization, the action database 9012 may also be parameterized. For example, viewers of a certain age group (e.g., children) may have preferred interactions with a video display device (e.g., a smart television) and may prefer e.g. “play” to “record”. For another example, different locations may have different slangs for a certain action. The vocabulary in the action database 9012 may have parameters such as age group, location, etc.

The catalog database 9011 may provide all vocabulary that match the inputted class parameters, as entity terms, to the NLG process 9013. The action database 9012 may provide part or all vocabulary, as intent terms, to the NLG process 9013. In the NLG process 9013, at least one synonym database 9013a may be used to generate synonyms for the intent terms, or the entity terms, or both, in the designed context. For example, in the video (e.g., smart television) context, the intent terms such as “play”, “record” may be synonymous with “show me”, “make a copy of”, respectively. The entity terms such as “Good Morning Britain” may hardly need synonyms since they are proper nouns. In another context, the entity terms may need synonyms. For example, when the context is a vending machine, the entity terms such as “apple juice” may be synonymous with “apple cider”, “apple extract” in a broader sense. The NLG process 9013 may be configured to connect or bypass the one or more synonym databases 9013a for entity/intent terms, depending on the context. It may assign a specified synonym database 9013a for a respective one of entity terms and/or intent terms. This may further increase accuracy of generated phrases, as the synonym database for entity terms may be focused on nouns and the synonym database for intent terms may be focused on verbs. It may decrease ambiguity caused by words such as “play” (interpretable as both a noun and a verb). These entity/intent terms and/or their synonyms may be combined to generate natural language phrases (e.g., commands) using syntax or grammar rules supplied by a syntactic database 9013b in the NLG process 9013. The process is similar to that described above with respect to FIG. 4 and will not be described herein in detail.

Another example of the specialized context with respect to the processes in FIG. 9 may be a voice-controlled vending machine. In this context, the catalog database 9011 may contain names related to different commodities. These names may be parameterized with parameters such as category (e.g., drink or snack), status (e.g., ready-made or on-site preparation), etc. A corresponding user interface may have dropdown boxes related to these parameters. The action database 9012 may contain words such as make, brew, sell me. And these words may be associated with part or all of the commodity names. For example, the action word “brew” may apply to a hot coffee prepared on-site and not to ready-made canned coffee. Based on user selection of the parameters on the interface (e.g., category, status), not only the catalog database 9011 but also the action database 9012 may export selective terms. The user interfaces (e.g. the interface 300, 500a, or 700) may include an option to select from a list (e.g., a pulldown list) of available contexts that the system is configured to support (e.g., contexts having context-specific databases of words and phrases).

The user interfaces for the voice sample generation processes may be manually operated by users or may be designed to automatically input parameters using known computer programming methods. For example, the interface as shown in FIG. 7A may be connected with an auto-input program which may automatically input each desired parameter in a predetermined order, trigger sample generation, and repeat the process for a different input. In that situation, the scale and speed of voice sample generation may be dramatically increased.

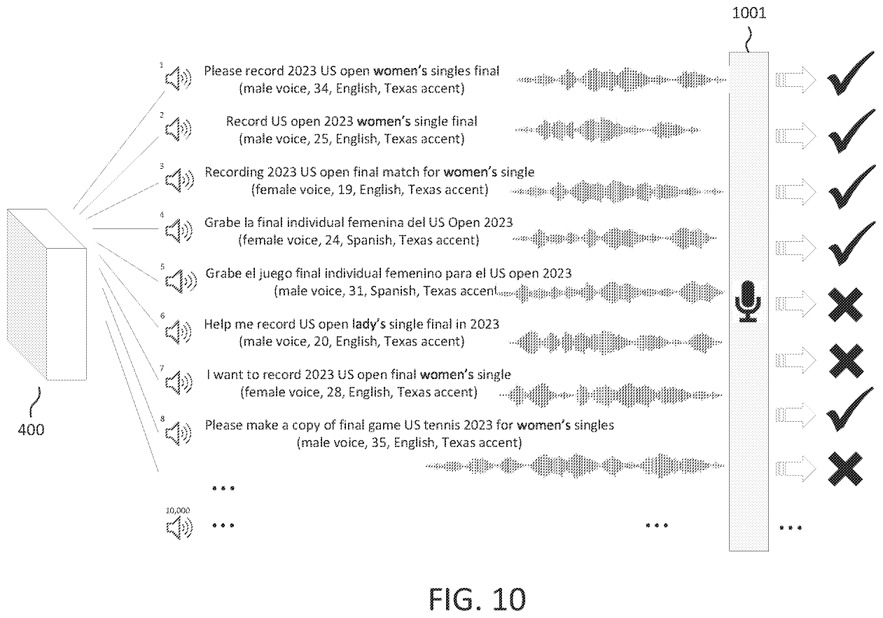

The voice samples generated in the examples in FIG. 3A-9 may be used for training voice recognition models. FIG. 10 shows an example of sending the simulated voice samples (or simulated spoken phrases) from FIG. 6 to a voice recognition system for testing the performance of the system. A voice recognition system 1001 may be a computing device 200 executing a voice recognition software process, and may have one or more voice recognition models such as Automatic Speech Recognition (ASR), Natural Language Understanding (NLU), etc. These voice recognition models may generate outputs or voice recognition results based on the inputted voice samples. The outputs or voice recognition results may be recognized transcripts, identified meanings, and/or end display on a screen. The outputs or voice recognition results may be evaluated and determined as correct results or errors (as illustrated, some with checkmarks were successfully recognized and correlated to the desired command, while the ones with “X” were not). The details of the determination will be described below with reference to other figures. In the example in FIG. 10, ten thousand voice samples may be sent to the voice recognition system 1001 for testing. These voice samples may be played directly to the voice recognition system 1001, mimicking a real-life situation. For example, they may be played aloud by a speaker 214, and detected by a microphone 208 in a computing device 200 that executes a voice recognition software process. The volume, distance between a voice sample player and the voice recognition system 1001, background noise, etc. may be adjusted to make it more realistic. Alternatively, these voice samples may be submitted to backend processing of the voice recognition system 1001. For example, the voice sample audio files may be sent (e.g., transmitted) via an audio port (e.g., a phone jack, an AUX input) of the voice recognition system 1001 and be played “internally” to the voice recognition models in the voice recognition system 1001. The voice samples may be generated in the same location as that of the voice recognition system, or they may be generated in a different location and transferred to the testing location via various methods such as internet transmission, cloud sharing, hardware transportation, etc. The outputs of testing may be evaluated in a way that will be described in detail hereinafter.

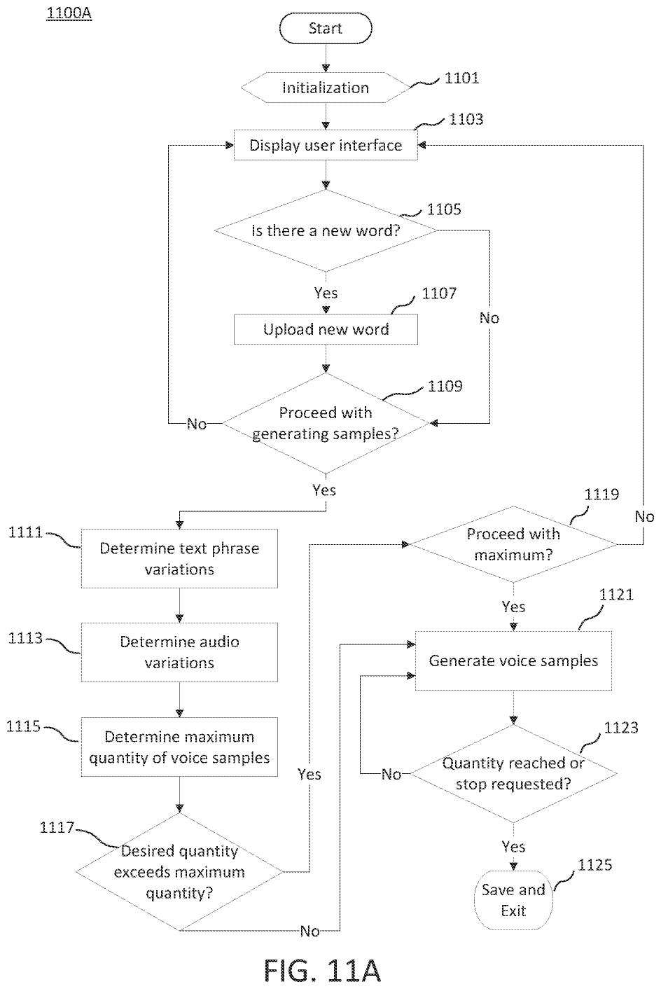

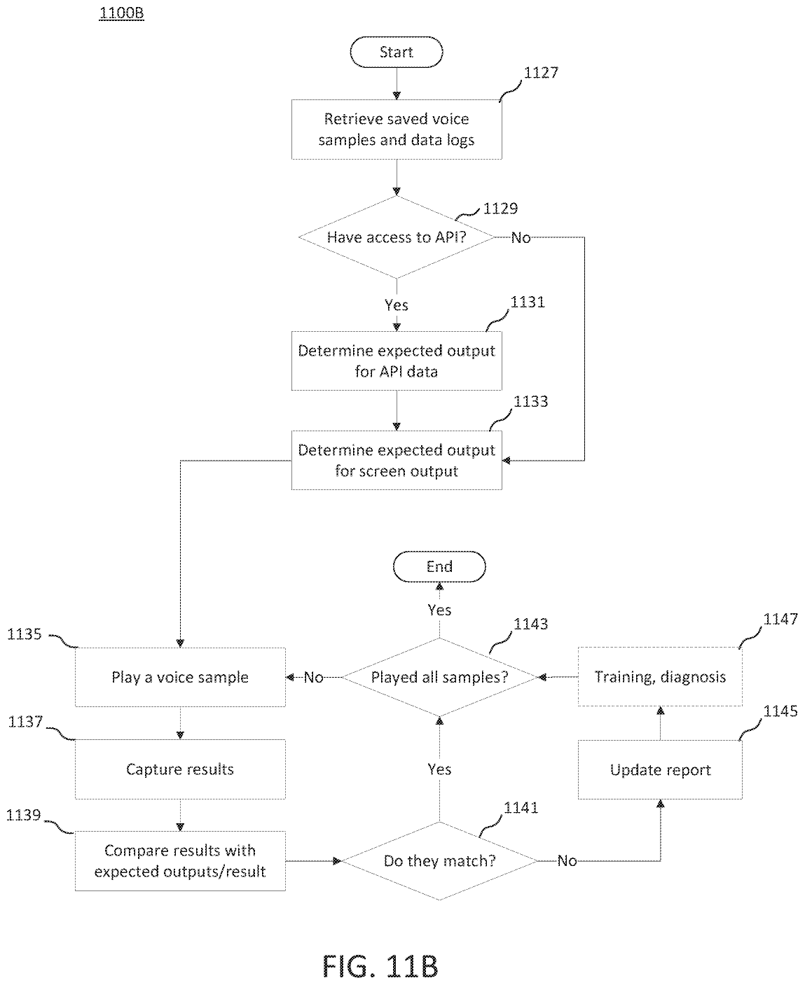

FIG. 11A is an example flowchart showing a voice sample generation process, and FIG. 11B is an example flowchart showing a testing process for a voice recognition system using the generated voice samples. The various steps may be performed by any computing device described herein, such as the language processing training server 123.

In step 1101, the process may be initialized. This may include retrieving the various databases and information discussed above, such as accent databases of the text-to-speech process 403, synonym databases 4012a, 9013a, syntactic database 4012b, 9013b, catalog database 9011, and action database 9012, etc.

In step 1103, a user interface (e.g., interface 300, 500a, 500b, 700) for generating voice samples may be outputted. The user interface may be any interface that realizes the functions such as inputting text phrases, inputting parameters related to audio characteristics and context/scope of voice samples, etc., designating desired quantity, format, file location of voice samples, uploading examples for new words, and/or so on. Examples of the user interface may be shown in e.g. FIG. 3A, 5A, 5B, 7A. Such interface may be designed and made using any existing software developing methods.

In step 1105, a determination may be made as to whether the user entered a new word in the user interface. As described above with respect to FIG. 3A and FIG. 3B, a new word may be a name or term that is not in English that may be hard or uncertain to pronounce in English, for example, the movie name “Encanto”, and a new word may also be any word that is not in the linguistic databases used in the voice sample generation process 1100A. A user may identify a new word and provide an example pronunciation for that new word. The computing device may identify a new word and notify the user. If the example pronunciation for a new word is provided, then in step 1107, the user's recording of the pronunciation may be uploaded to a linguistic database (e.g., text-to-speech process 403). In step 1109, a determination may be made as to whether generating voice samples should proceed. If a new word is not provided with an example pronunciation, audio may still be generated for that word based on a general pronunciation rule in that language.

In step 1107, the new word may be uploaded to the linguistic databases. Specifically, an audio file containing an example pronunciation of the new word may be uploaded to the linguistic databases. This audio file may be used to generate voice samples based on an input text phrase, together with other audio files in the databases.

In step 1109, a determination may be made as to whether the user has finished entering criteria, and is ready for the voice samples to be generated. If a determination is made that voice sample generation should be started, for example, if the user presses the button 308, 504, or 707, then in step 1111, the textual variations of the input phrase may be determined, as will be discussed below. If a determination is made that voice sample generation should not be started, for example, if the user has not pressed the button 308, 504, or 707, then in step 1103, a user interface such as the interface 300, 500a, 500b, or 700 may be and/or remain displayed.

In step 1111, a determination may be made as to the text phrase variations that may be generated. As described above with respect to examples in FIG. 4 and/or FIG. 9, text phrase variations may be generated, for example, based on an input text phrase using an NLU process 4011, a synonym database 4012a, a syntactic database 4012b, and/or based on class parameters using at least a catalog database 9011, an action database 9012, a synonym database 9013a, and a syntactic database 9013b. In step 1111, for example, a computing device 200 (e.g., language processing training server 123) may extract entity/intent terms by using the NLU process 4011 from an input text phrase. The computing device 200 may generate synonyms for each of the entity/intent terms by using the synonym database 4012a. The computing device 200 may retrieve syntax or grammar rules from the syntactic database 4012b and connect the entity and intent terms and their synonyms to make alternative text phrases 402 (e.g., the ones as shown in FIG. 6). The quantity of the text phrase variations (e.g., alternative text phrases 402 plus the input text phrase) may be determined as well, for example, by counting the generated alternative text phrases. For another example, the computing device 200 (e.g., language processing training server 123) may retrieve entity/intent terms from the catalog database 9011 and the action database 9012 based on input class parameters. The computing device 200 may generate synonyms for one or both of entity and intent terms by using the synonym database 9013a. The computing device 200 may retrieve syntax or grammar rules from the syntactic database 9013b and connect the entity and intent terms and their synonyms to make diversified text phrases 902 (e.g., the ones as shown in FIG. 8). The quantity of the text phrase variations (e.g., diversified text phrases 902) may be determined as well, for example, by counting the generated diversified text phrases.

In step 1113, a determination may be made as to the audio variations that may be generated by a computing device. As described above with respect to examples in FIG. 4 and/or FIG. 9, audio variations may be realized by voice data (e.g., audio files) selected, for example, based on inputted audio parameters or speaker parameters. The audio variations may be different accents. The audio variations may involve more than one language. The audio variations may involve country/region, gender, age, and/or so on. In step 1113, for example, the audio variations may be realized by selecting, in an audio database (e.g., accent database) of a text-to-speech process 403 or 903, voice data (e.g., audio files) with parameters that match the inputted audio parameters or speaker parameters. The computing device 200 (e.g., language processing training server 123) may retrieve these voice data (e.g., audio files) from the audio database (e.g., accent database), for example, based on the inputted audio parameters or speaker parameters. The retrieved voice data may be used for combining with text phrase variations generated in step 1111 to generate voice samples in the steps (e.g., step 1121) below. The computing device 200 may determine the quantity of audio variations as well, for example, by counting the quantity of the retrieved audio files. This may indicate the quantity of audio variations that the system can create for each text phrase.

In step 1113, if the inputted parameters comprise weights, for example, in the example as shown in FIG. 5B, the voice data (e.g., audio files) may be selected with consideration to the weights. For example, there may be 500 audio files that match the parameters male, age 19-35, English, and there may be 200 audio files that match the parameters male, age 19-35, Spanish. As the weights for English and Spanish are 73% and 27%, respectively, in the example of FIG. 5B, the computing device 200 may retain 500 audio files that match the parameters male, age 19-35, English, and may select (e.g., randomly) 185 audio files that match the parameters male, age 19-35, Spanish, to meet the weight requirement (500/185 is around 2.7, which equals to 73%/27% which is also around 2.7). The 685 (500 plus 185) audio files may represent a maximum total quantity of audio files that meet the weight requirement.

Similarly, there may be 600 audio files that match the parameters female, age 19-35, English, and there may be 400 audio files that match the parameters female, age 19-35, Spanish. Based on the same weights as mentioned above, the computing device 200 may retain 600 audio files that match the parameters female, age 19-35, English, and may select (e.g., randomly) 222 audio files that match the parameters female, age 19-35, Spanish, to meet the weight requirement (600/222 is around 2.7, which equals to 73%/27% which is also around 2.7). Additionally, the weights for male and female are 60% and 40%, respectively, in the example of FIG. 5B. The computing device 200 has selected 685 (500 plus 185) male audio files and 822 (600 plus 222) female audio files. To meet the above weight requirement for male and female, the computing device 200 may retain 685 male audio files and may select (e.g., randomly) 457 female audio files (685/457 is around 1.5, which equals to 60%/40% which is 1.5), as the final audio files to be retrieved. And the quantity of the retrieved audio files may be counted as the quantity of audio variations, which is 1,142 (685 plus 457) in this example.

In step 1115, a determination may be made as to a maximum quantity of voice samples that may be generated using the quantity of text phrase variations from step 1111 and the quantity of audio variations from step 1113. For example, the computing device 200 may multiply the quantity of text phrase variations as determined in step 1111 and the quantity of audio variations as determined in step 1113. For example, the quantity of text phrase variations as determined in step 1111 may be 950, and the quantity of audio variations as determined in step 1113 may be 1,142, then a maximum quantity of voice samples may be 950 times 1,142 which equals 1,084,900. This maximum quantity may indicate how many audio samples are possible given the user's inputted parameters, and may be used to determine whether (and how) the user's desired quantity of voice samples (e.g., from an input area (or a first field) 501) may be satisfied.

In step 1117, a comparison may be made between the maximum quantity of voice samples and a desired quantity of voice samples as inputted by a user (e.g., input area 501), for example, by a computing device 200. If the desired quantity does not exceed the maximum quantity, which may indicate that the desired quantity of voice samples may be picked (e.g., randomly) from the maximum quantity of voice samples (if maximum quantity exceeds desired quantity), or the maximum quantity of voice samples may be used as the desired quantity of voice samples (if maximum quantity equals to desired quantity), then in step 1121, the computing device 200 may proceed with generating voice samples. If the desired quantity exceeds the maximum quantity, which may indicate an error, in step 1119, the computing device 200 may determine if it should proceed with the maximum quantity. For example, an error message may appear to ask the user if it is OK to proceed with generating the maximum quantity of voice samples. The error message may also give the user an option to return to an earlier step where the user may revise parameters and/or desired quantity. If there is no input of desired quantity of voice samples (e.g., in the situation of FIG. 7A), a determination may be made that the desired quantity does not exceed the maximum quantity.

In step 1119, if a determination is made that the computing device will proceed with the maximum quantity, in step 1121, the computing device may proceed to generate voice samples. If a determination is made that the computing device will not proceed with the maximum quantity, a user interface (e.g., interface 300, 500a, 500b) may be displayed in step 1103 for the user to revise the desired quantity or the parameters.

In step 1121, voice samples may be generated based on the results from steps 1111 and 1113. As described above in detail with respect to FIGS. 4 and 9, the computing device 200 may select (e.g., randomly) a text phrase from the generated text phrase variations (e.g., the ones as shown in FIG. 6 or FIG. 8) in step 1111, select (e.g., randomly) an audio file from the retrieved audio files in step 1113, and synthesize the text phrase with the audio file to generate a voice sample, using a text-to-speech process (e.g., 403 or 903). As described above, the computing device 200 may comprise a counter to count the quantity of generated voice samples, As also described above, the computing device may further comprise a calculator to calculate desired quantities of voice samples that match the parameters with different weights.

In step 1123, a determination may be made as to whether a quantity of voice samples has been reached or if a stop request has been made. The quantity of voice samples may be a desired quantity inputted by a user (e.g., input area 501) or may be a maximum quantity as determined in step 1115. The stop request may be made, for example, by clicking a button on a user interface (e.g., button 708 in FIG. 7B). For example, the user interface (e.g., the one in FIG. 7B) may indicate a current quantity of voice samples that have been generated, so that the user can see the progress and can choose to stop it if the user wishes. If the determination is that the quantity has not been reached and a stop request has not been made, the computing device 200 may continue generating voice samples in step 1121. If the determination is that the quantity has been reached or that the stop request has been made, in step 1125, the voice samples already generated may be saved and the voice sample generation process 1100A may be exited.

In step 1125, the generated voice samples may be saved to a default location or a designated location (e.g., input 307) in the computing device 200 (e.g., the language processing training server 123). The voice sample generation process 1100A may end.

During the process of generating voice samples, there may be data logs produced, for example, by the computing device 200, based on the input parameters. The data logs may comprise expected result such as expected text. The expected text may be text that a voice recognition system 1001 may recognize if the voice recognition system 1001 processes the simulated voice samples correctly. For example, in step 1111, as described above, the NLU process 4011 may generate entity and intent terms, which are used to generate alternative text phrases 402. The catalog database 9011 and the action database 9012 may generate entity and intent terms, which are used to generate diversified text phrases 902. These entity and intent terms as well as the text phrases may be the expected text, and may be transient data in the process 1100A if not recorded. The computing device 200 may record and/or save these transient data (or data logs) such as entity and intent terms as well as the text phrases. These recorded data (e.g., expected text) may be useful for processes that use the voice samples. For example, in a voice sample testing process 1100B which will be described below, these recorded data (e.g., expected text) may be retrieved as expected results/outputs for testing voice recognition models (e.g., ASR, NLU) using the voice samples. Each voice sample and associated entity, intent, and text phrase may be given IDs or serial numbers that track the correspondence between them. Therefore, a testing result of each voice sample may be processed and compared with the associated expected text such as entity, intent, and/or text phrase for this voice sample, as will be described in detail below.

FIG. 11B is an example flowchart showing a testing process 1100B for a voice recognition system 1001 using the plurality of voice samples (or spoken phrases) generated in the process 1100A. In the testing process 1100B, each of the generated voice samples (e.g., variations for performing a voice command) may be supplied to the voice recognition system 1001, and then the reaction of the voice recognition system 1001 may be monitored to determine if the voice sample caused an expected result (e.g., if the voice sample successfully resulted in recognizing a command to record the movie “Encanto”).

In FIG. 11B, in step 1127, the saved voice samples and data logs (e.g., expected text) from the process 1100A may be retrieved and/or received, for example, by a computing device (e.g., a computing device 200). The saved voice samples may be audio files of a pre-selected format. The data logs may include entity and intent terms, as well as text phrases as described above. These data logs may comprise information indicating an expected result for the voice samples. The computing device may retrieve the voice sample files and data log files through internet transmission, cloud sharing, hardware transportation, and/or so on, and may save them in a designated location (e.g., a buffer memory in the computing device) to be used for testing.

In step 1129, a determination may be made as to whether the Application Programming Interface (API) of the voice recognition system 1001 may be accessed. Access to the API may determine how the results of the testing may be received from the voice recognition system (e.g., voice recognition model) 1001. If access to the API is available, then after each voice command is submitted to the voice recognition system 1001, the voice recognition system 1001 may return an API value indicating what (if any) text phrase, entity and intent were recognized. If access to the API is unavailable, then after each voice command is submitted to the voice recognition system 1001, a screen output of the voice recognition system 1001 may be examined to determine whether the voice command resulted in the expected result. In step 1129, if a determination is made that access to the API is available, then in step 1131, the computing device may determine expected output/result for API data. If a determination is made that access to the API is unavailable (e.g., a black-box voice recognition system is tested), then in step 1133, the computing device may determine expected output/result for the screen output.

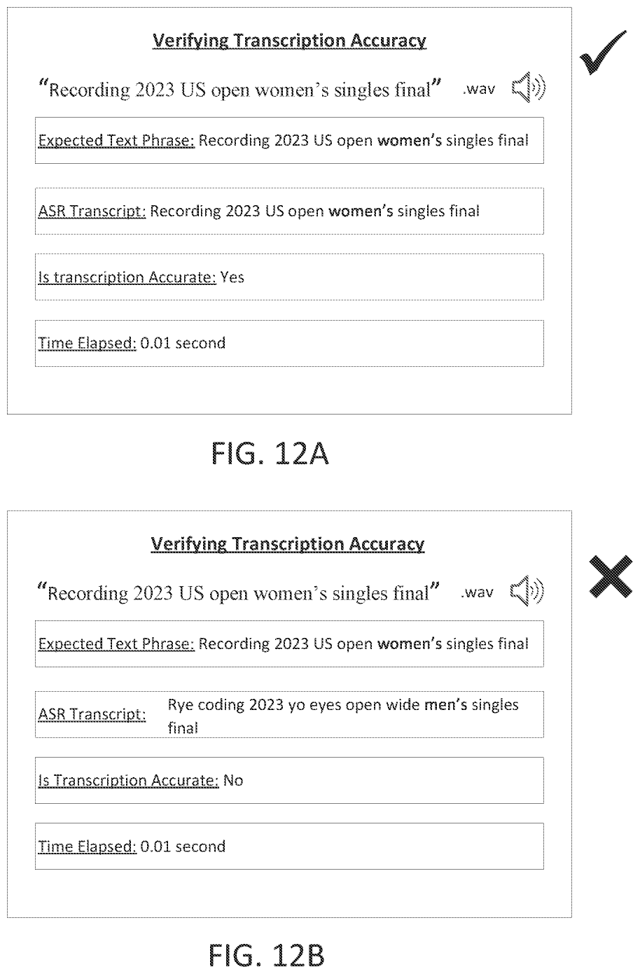

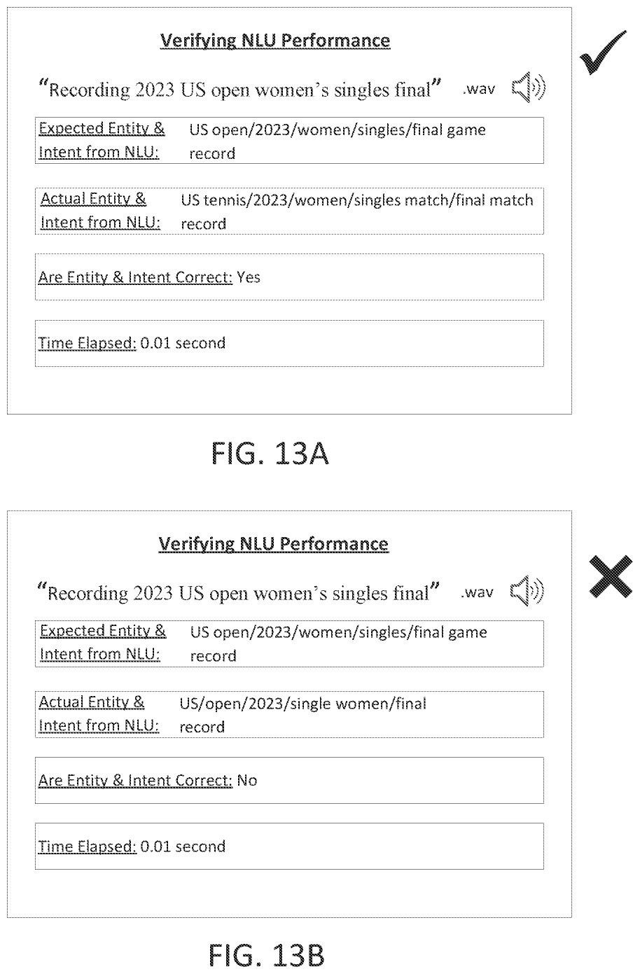

In step 1131, a determination may be made as to the expected outputs (or expected results, expected API values) for API data returned by the voice recognition system 1001. As described above, the voice recognition system 1001 may comprise voice recognition models such as ASR and NLU. The ASR may recognize an audio phrase into a text phrase or transcript. The NLU may identify entity and intent (e.g., entity and intent terms) from the transcript. The recognized transcript, and the entity and intent terms may be at least part of the API data (e.g., API return values after sending the simulated voice samples to the voice recognition models). The expected outputs or results may be expected API values of the voice recognition models such as the expected text or correct text phrase, entity and intent terms as shown in the data logs retrieved from the process 1100A in step 1127. These data logs may be retained for use in step 1139. Examples of the API data and expected outputs of ASR and NLU may be seen in FIG. 12A-13B, as will be described below.

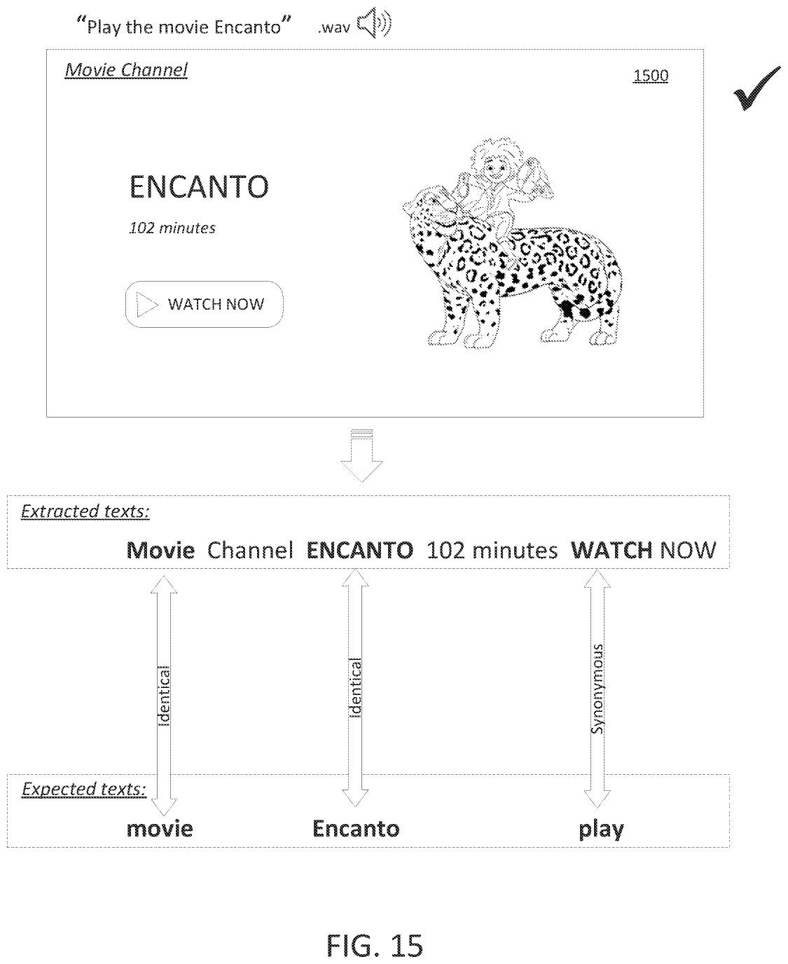

In step 1133, a determination may be made as to the expected outputs (or expected results, expected text) for screen outputs (or user interfaces) of the voice recognition system (e.g., voice recognition model) 1001. For example, a screen output may be a screen display (e.g., screen image) shown on an electronic display device (e.g., a smart television) after (e.g., in response to) receiving a simulated voice sample (e.g., voice command). A screen output may contain texts. For the screen output, an expected output may contain at least part of the expected text or correct texts as indicated by entity and/or intent as shown in the data logs retrieved from the process 1100A in step 1127. Examples of the screen outputs (e.g., screen 1500, 1600, 1700, 1701) may be seen in FIG. 15-17B, as will be described below. FIG. 15 also shows an example of comparison between texts on the screen and expected output (or expected text). In FIG. 11B, note that step 1133 may still be performed, even if API data is accessible. This is to provide additional evaluation from an end user's (e.g., a television user's) perspective. By doing so, the testing process 1100B may become a more complete and end-to-end process.

In step 1135, a voice sample of the plurality of voice samples may be sent to and/or played for the voice recognition system (e.g., voice recognition model) 1001. The detailed ways of playing the voice sample have been described with respect to FIG. 10. Compared to using recorded real-life commands for testing, using simulated voice samples may make testing more comprehensive and much less expensive, and it may also protect user privacy.

In step 1137, results (e.g. voice recognition results) from the voice recognition system 1001 in response to the sent and/or played voice sample may be captured and/or received. The captured results may be API data and/or screen outputs (e.g., screen images), depending on the determination result in step 1129. For example, if a voice sample “Play the movie Encanto” is played for the voice recognition system 1001, the API data may comprise a transcript of what the system recognized, and recognized entity and intent terms from the transcript. Examples of the transcript may be “Play the movie Encanto” (which matches the original text phrase of the voice sample), or “Play the movie un canto” (which does not match the original text phrase of the voice sample). Examples of the recognized entity and intent terms may be “movie/Encanto; play” (which match the original entity/intent of the voice sample), or “movie/un canto; play” (which do not match the original entity/intent of the voice sample). For the screen outputs, screen-capturing software (e.g., any screenshot tools, such as Snip & Sketch) may be used to capture the screen such as the screen 1500, 1600, 1700, 1701 (i.e. to take a screenshot). A screenshot processing tool (e.g., any screenshot text capturing or recording tool, such as Optical Character Recognition (OCR)) may be used to generate (e.g., extract) texts (or resulting text) from the captured screen (e.g., screen image). In the example of “Play the movie Encanto”, a screen output may be a screen display of the movie Encanto, with the name “Encanto” and a button with text (e.g., “Play”, “Watch now”) for triggering playing on the screen (see FIG. 15). The screen output may be captured as an image file, and the text “Encanto”, “Play” and/or so on may be extracted from the image file by using a tool such as OCR.

In step 1139, the captured results (e.g., voice recognition results) obtained in step 1137 may be compared with expected outputs/results which have been determined in step 1131 and/or step 1133. For example, for the voice sample “Play the movie Encanto”, a captured transcript “Play the movie un canto” may be compared with a text phrase “Play the movie Encanto” from step 1131. The extracted text “Encanto” and “play” from a screen output may be compared with the expected text such as the entity/intent terms “movie/Encanto; play” from step 1133. Any existing text comparison methods may be used for the comparison.

In step 1141, a determination may be made as to whether a captured result matches the expected output/result. There may be different standards for the determination. For example, the comparison for a transcript (e.g., by comparing an expected API value with an API return value) may be strict or verbatim, and a matching transcript may need to be identical or almost identical to an expected output (e.g., expected text). For the example voice sample “Play the movie Encanto”, the expected output may be “Play the movie Encanto”. A transcript saying “Play the movie Encanto” is identical to and thus matches the expected output. A transcript saying “Play movie Encanto” is almost identical to the expected output and may be considered matching, since “the” may be pronounced lightly and quickly in the voice sample and is an insignificant word in this phrase. A transcript saying “Play the movie un canto” is different from the expected output and is not considered matching. For another example, the comparison for entity and intent (e.g., by comparing an expected API value with an API return value) may be less strict or not verbatim, and a matching entity/intent may need to be identical or synonymous to the expected outputs (e.g., expected text) in order to match the expected outputs (e.g., expected text). For the example voice sample “Play the movie Encanto”, the expected output may be “movie/Encanto; play”. An entity/intent (e.g., in the API data) saying “film/Encanto; show” is synonymous to the expected output and thus may be considered matching the expected output. Another entity/intent saying “movie/un canto; game” is not identical or synonymous to the expected output and is not considered matching the expected output. For another example, generated (e.g., extracted) texts (e.g., resulting text) may be compared with expected output (e.g., expected text) associated with the voice sample. The resulting text (e.g., an OCR result) from a screen (e.g. screen image) may be considered matching an expected text if a predetermined degree of overlap exists between the resulting text and the expected text. FIG. 15 shows an example of the comparison and will be described in detail below. If a determination is made that the captured result matches the expected output/result, then in step 1143, a further determination may be made as to whether all voice samples have been played. If a determination is made that the captured result does not match the expected output/result, then in step 1145, the determination result may be reported.

In step 1143, a determination may be made as to whether all voice samples retrieved in step 1127 have been played. If a determination is made that not all voice samples have been played, in step 1135, a next voice sample may be played. If a determination is made that all voice samples have been played, the testing process 1100B may come to an end.

In step 1145, a report may be updated with errors of the voice recognition system 1001 with regard to specific voice samples. The report may list the voice samples with which the voice recognition system 1001 failed the test. The report may also record details such as the recognized transcript, entity/intent, and the expect outputs of the voice samples. The report may be used as a record for evaluation, trouble-shooting, and training purposes.

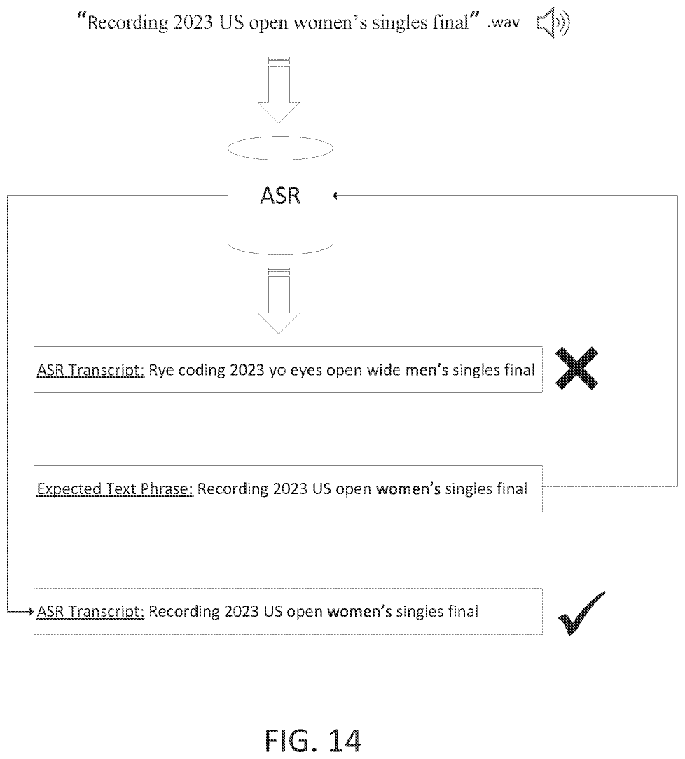

In step 1147, diagnosis and/or training of the voice recognition system 1001 may be performed. One or more operation parameters of the voice recognition system (e.g., voice recognition model) may be revised, for example, based on the voice recognition results and/or the comparison. For example, an expected output (or expected result, e.g., expected text) for a particular voice sample may be sent to the voice recognition system 1001 (e.g., a voice recognition model such as ASR) as feedback for machine learning purposes (e.g., see FIG. 14), and change or revisions may occur in the voice recognition system 1001 (e.g., a voice recognition model such as ASR). After the diagnosis and/or training for one voice sample is done, in 1143, a determination may be made as to whether all voice samples have been played. Step 1147 may be removed and may be performed after the whole testing process 100B is completed.

FIG. 12 to FIG. 17 show examples of the evaluation and training processes as described in the steps above. FIG. 12A and FIG. 12B show an example of verifying transcription accuracy for ASR. The ASR may be used in the voice recognition system 1001. In FIG. 12A, for an example voice sample, the expected text phrase (or expected text) is “Recording 2023 US open women's singles final”. The ASR transcript is “Recording 2023 US open women's singles final” which is the same as the expected text phrase. The transcription is accurate, and the evaluation result is success as indicated by the checkmark. In FIG. 12B, with the same voice sample and expected text phrase, the ASR transcript is “Rye coding 2023 yo eyes open wide men's singles final” which is not the same as the expected text phrase “Recording 2023 US open women's singles final”. The transcription is not accurate, and the evaluation result is error as indicated by the “X” mark. Note that time lapse or latency may also be recorded and evaluated. In both FIG. 12A and FIG. 12B, the time elapsed is 0.01 second. This may be desirable. For example, if it may take several seconds to obtain a transcript of ASR from a voice sample, it may be considered slow and may get a corresponding evaluation result.

FIG. 13A and FIG. 13B show an example of verifying the performance of NLU. The NLU may be used with ASR in the voice recognition system 1001. In FIG. 13A, for a voice sample “Recording 2023 US open women's singles final”, an expected entity and intent (or expected text) identified by NLU may be “US open/2023/women/singles/final game; record” (entity terms and intent term separated by semicolon). An actual entity and intent extracted by NLU may be “US tennis/2023/women/singles match/final match; record”. Although some of the entity terms may look different from those expected entity terms, they are synonymous to those expected ones. For example, “US tennis” is synonymous to “US open”, and “singles” is synonymous to “singles match” in the sports context. Thus, these actual entity and intent are correct, and the evaluation result is success as indicated by the checkmark. In FIG. 13B, for the same voice sample and expected entity and intent, the actual entity and intent may be “US/open/2023/single women/final; record”. Some of the entity terms are not the same or synonymous with the expected entity terms. For example, “single women” may mean something very different from “singles” even in the same context. Thus, these actual entity and intent are not correct, and the evaluation result is error as indicated by the “X” mark. Similarly, the time lapse or latency may also be recorded and evaluated.

FIG. 14 shows an example process of training ASR to generate the correct transcript. In this example, after hearing a voice sample “Recording 2023 US open women's singles final”, the ASR initially provides a transcript “Rye coding 2023 yo eyes open wide men's singles final” which is incorrect as described in FIG. 12B. The expected text phrase (or expected text) “Recording 2023 US open women's singles final” may be sent to the ASR which may learn and build a correct connection between the transcript and the voice sample. As a result of this training, the next time the ASR hears the same voice sample, it may generate the correct transcript. Although not shown, the process of training NLU may be similar. The expected entity and intent terms (or expected text) may be sent to NLU as feedback for NLU to learn and build a correct connection between the transcript and the entity and intent terms.

FIG. 15 shows an example of screen output for a voice sample and an example process for evaluating the screen output. Screen 1500 shows an example screen output as a result of playing the voice sample “Play the movie Encanto”. In the testing process, a screenshot may be taken of this screen, and a screenshot text capturing or recording tool (e.g., OCR) may extract texts from this screenshot. In this example, the extracted texts may include “Movie”, “Channel”, “ENCANTO”, “102”, “minutes”, “WATCH”, and “NOW”. The expected entity and intent texts (or expected text) from the voice sample may include “movie”, “Encanto”, and “play”. The extracted texts may be compared with the expected texts and the expected texts may be found to exist among the extracted texts, either identical or as a synonym. For example, “movie” is identical to “Movie”, and “play” is synonymous to “WATCH” in the movie context. Thus, a determination may be made that the screen output is correct for that voice sample.

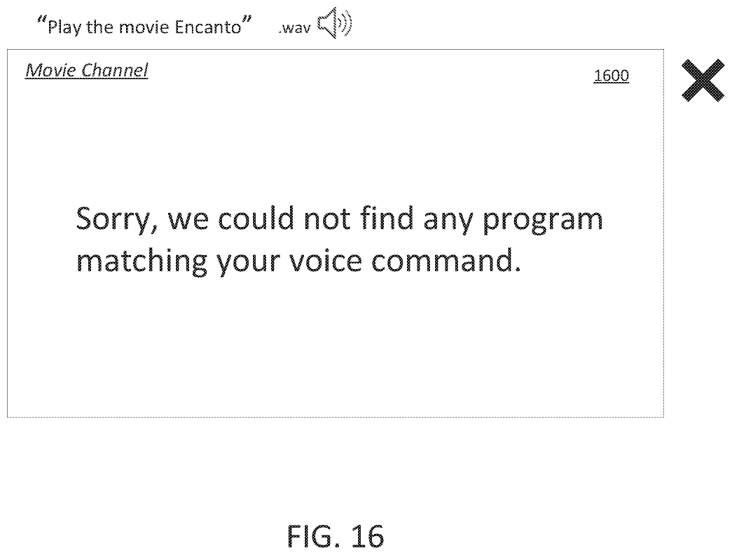

FIG. 16 shows an example of another screen output for a voice sample. In this example, in response to the voice sample “Play the movie Encanto”, the screen 1600 may contain a notification saying “Sorry, we could not find any program matching your voice command.” There may be more than one cause for this. The voice recognition system 1001 may fail to work correctly for this voice sample. For example, the ASR may transcribe the voice sample incorrectly, generating a transcript “Play the movie un canto” which is different from “Play the movie Encanto.” In the context of a voice-controlled electronic device (e.g., a smart television), the electronic device may not be able to find a movie called “un canto” in its library. Another possibility may be that the electronic device does not have the movie Encanto, even though the voice recognition system 1001 processed the voice sample correctly. Since the screen output is an error for this voice sample, it may be reported and further training and/or diagnosis may be performed, as described above with respect to FIG. 11B.

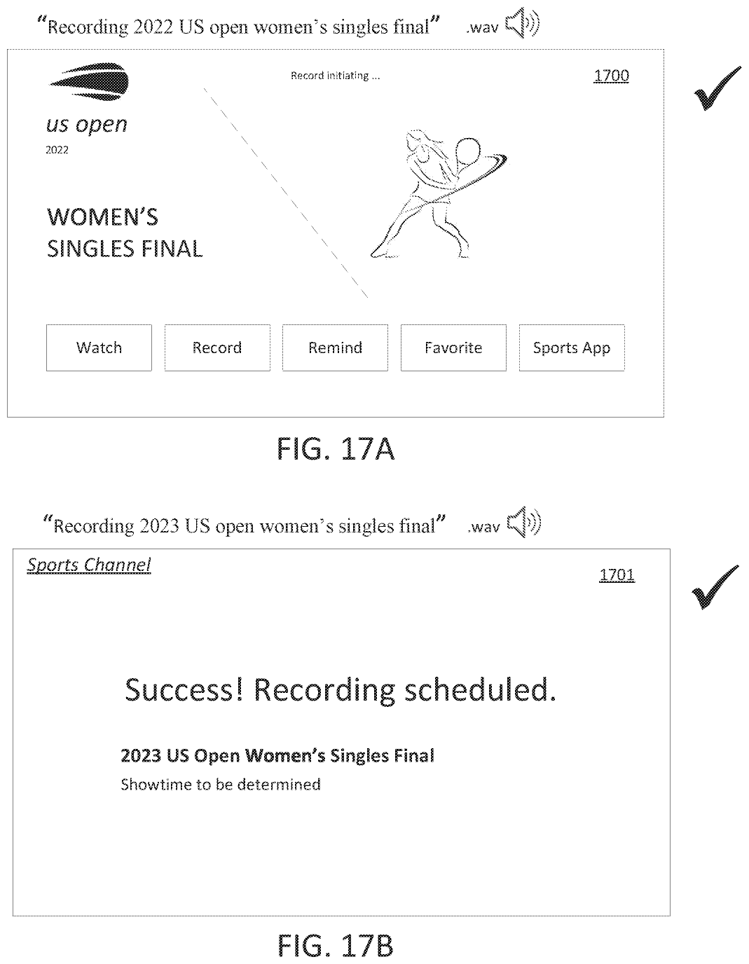

FIG. 17A and FIG. 17B show two more examples of screen output for voice samples. In FIG. 17A, the screen 1700 is a correct output for the voice sample “Recording 2022 US open women's singles final.” The screen 1700 may show a cover page for a women's singles final match in the 2022 US Open Tennis Championships, with action buttons such as Watch, Record. There is also a line showing “Record initiating” indicating that the command for recording this match is being processed. FIG. 17B shows a screen 1701 which is a correct output for the voice sample “Recording 2023 US open women's singles final.” Since this 2023 US open match is a future event that is not in the library yet, there is no cover page to show. However, the voice recognition system 1001 processed this voice sample or command correctly, and the voice-controlled electronic device (e.g., a smart television) may accept the request of scheduling the recording for this future event. The electronic device may be able to do a tentative scheduling because there are similar past events (e.g., the 2022 US open women's singles final) in its library. For example, when a showtime has been determined for the 2023 event, the electronic device may update the recording schedule based on the determined showtime and may perform the recording when the showtime comes.

It may be possible that the whole process from voice sample generation to voice recognition system/model testing/training may be automated. The whole process may be triggered automatically, for example, based on received updates to a future program schedule. For example, there may be a new event monitoring module in the computing device 200 that may monitor news feeds, social media trends, etc. and determine if a new event is going to happen that may involve updated vocabulary. For example, the monitoring module may detect the 2024 Olympics which is going to be held in Paris, France. The module may trigger the process by instructing searching and collecting names and their pronunciations, e.g. athlete names, that are not in the existing databases. Then the whole process may start automatically to generate a plurality of simulated voice samples (or simulated spoken phrases) related to those new names, to test existing voice recognition systems, and to train the voice recognition systems to prepare them for the new Olympic games.

The screen mentioned in this specification may be on any product screen that may display the end outputs of a voice recognition model/device/system, for example, television screen, phone screen, tablet screen, virtual reality screen, and/or so on.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
receiving, by a computing device, a request for generating simulated spoken phrases corresponding to a voice command;
generating, by the computing device and based on the request, a plurality of simulated spoken phrases corresponding to the voice command; and
using the simulated spoken phrases to train a voice recognition model.

2. The method of claim 1, wherein the generating the plurality of simulated spoken phrases comprises:
receiving, by the computing device, a first text phrase; and
automatically generating, by the computing device, based on the first text phrase, and based on one or more linguistic databases, the plurality of simulated spoken phrases, wherein the plurality of simulated spoken phrases comprise grammatical variants of the first text phrase.

3. The method of claim 1, wherein the generating the plurality of simulated spoken phrases comprises:
receiving, by the computing device, a first text phrase; and
automatically generating, by the computing device, based on the first text phrase, based on a synonym database, and based on a syntactic database, the plurality of simulated spoken phrases, wherein the plurality of simulated spoken phrases comprise grammatical variants of the first text phrase.

4. The method of claim 1, wherein the generating the plurality of simulated spoken phrases comprises:
receiving, by the computing device, a first text phrase; and
sending the first text phrase to a natural language understanding (NLU) process, and receiving from the NLU process, information indicating entity and intent terms based on the first text phrase; and
automatically generating, by the computing device, based on the first text phrase, based on the entity and intent terms, and based on one or more linguistic databases, the plurality of simulated spoken phrases, wherein the plurality of simulated spoken phrases comprise grammatical variants of the first text phrase.

5. The method of claim 1, further comprising:
causing output of a user interface screen; and
receiving, via a first field of the user interface screen, a value indicating a quantity of desired simulated spoken phrases.

6. The method of claim 1, further comprising:
causing output of a user interface screen; and
receiving, via the user interface screen, a plurality of percentage values indicating a desired language distribution for the plurality of simulated spoken phrases.

7. The method of claim 1, further comprising:
causing output of a user interface screen; and
receiving, via the user interface screen, a plurality of percentage values indicating a desired regional accent distribution for the plurality of simulated spoken phrases.

8. The method of claim 1, further comprising:
sending the plurality of simulated spoken phrases to a voice recognition model of a voice-enabled system;
receiving, from the voice recognition model, voice recognition results for the simulated spoken phrases; and
revising, based on the voice recognition results, one or more operation parameters of the voice recognition model.

9. The method of claim 1, further comprising:
sending the plurality of simulated spoken phrases to a voice recognition model of a voice-enabled system;
receiving, from the voice recognition model, screen images of voice recognition results for the simulated spoken phrases;
performing optical character recognition, on the screen images, to generate resulting text;
comparing the resulting text with expected text associated with the plurality of simulated spoken phrases; and
revising, based on the comparing, one or more operation parameters of the voice recognition model.

10. The method of claim 1, further comprising receiving updates to a future program schedule, and wherein the generating the plurality of simulated spoken phrases is performed automatically based on the updates to the future program schedule.

11. The method of claim 1, further comprising generating, by the computing device and based on the request, an expected result associated with the plurality of simulated spoken phrases.

12. A method comprising:
receiving, by a computing device, a plurality of simulated spoken phrases, wherein the simulated spoken phrases are variations for performing a voice command;
receiving, by the computing device, information indicating an expected result for the simulated spoken phrases;
sending, by the computing device, the plurality of simulated spoken phrases to a voice recognition model;
receiving, from the voice recognition model, voice recognition results for the simulated spoken phrases;
comparing the voice recognition results with expected result; and
revising, based on the comparing, one or more operation parameters of the voice recognition model.

13. The method of claim 12, wherein the expected result comprises expected text for a user interface of the voice recognition model,
wherein the voice recognition results comprise images of the user interface after sending the simulated spoken phrases to the voice recognition model,
wherein the method further comprises performing optical character recognition on the images of the user interface to generate optical character recognition results, and
wherein the comparing comprises comparing the expected text with the optical character recognition results.

14. The method of claim 12, wherein the expected result comprises expected application program interface (API) values of the voice recognition model,
wherein the voice recognition results comprise API return values after sending the simulated spoken phrases to the voice recognition model, and
wherein the comparing comprises comparing the expected API values with the API return values.

15. The method of claim 12, further comprising:
automatically generating the plurality of simulated spoken phrases by varying an input text phrase based on a linguistic database.

16. The method of claim 12, further comprising:
receiving, by the computing device, a first text phrase;
sending the first text phrase to a natural language understanding (NLU) process, and receiving from the NLU process, information indicating entity and intent terms based on the first text phrase; and
automatically generating, by the computing device, based on the first text phrase, based on the entity and intent terms, and based on one or more linguistic databases, the plurality of simulated spoken phrases, wherein the plurality of simulated spoken phrases comprises grammatical variants of the first text phrase.

17. The method of claim 12, further comprising:
causing output of a user interface screen; and
receiving, via the user interface screen, a plurality of percentage values indicating a desired regional accent distribution for the plurality of simulated spoken phrases.

18. A method comprising:
causing output of a voice sample generation user interface comprising:
a first field configured to receive a value indicating a desired quantity of a plurality of voice samples;
a second field configured to receive a desired input text for generation of the plurality of voice samples;
receiving, via the user interface, the desired input text and the desired quantity for generation of the plurality of voice samples; and
generating, based on the desired input text and the desired quantity, the plurality of voice samples.

19. The method of claim 18, wherein the user interface further comprises:
an option to provide different desired percentage distributions for different languages of the voice samples.

20. The method of claim 18, wherein the user interface further comprises:
an option to provide different desired percentage distributions for different regional accents of the voice samples.

21. The method of claim 18, further comprising:
causing output, during the generating of the plurality of voice samples, of:
an updated value indicating a current quantity of generated voice samples; and
an option to stop further generation of voice samples.
